(19) United States
(12) Patent Application Publication
(10) Pub. No.: US 2021/0386106 A1
(43) Pub. Date: Dec. 16, 2021

(54) INTERMITTENT FASTING BAR/DRINK THAT MAINTAINS AND EXTENDS THE FASTING STATE

(71) Applicant: L-NUTRA, INC., Plano, TX (US)

(72) Inventor: Fabrizio SCHIRANO, Plano, TX (US)

(21) Appl. No.: 17/347,212

(22) Filed: Jun. 14, 2021

Related U.S. Application Data
(60) Provisional application No. 63/105,322, filed on Oct. 25, 2020.
(60) Provisional application No. 63/038,894, filed on Jun. 14, 2020.

(51) Int. Cl. A23L 33/00; A23L 33/115; A23L 33/125; A23L 33/185; A23L 33/21; A23L 25/00; A23L 33/175; A23L 2/39; A23L 2/66

(52) U.S. Cl. CPC A23L 33/30; A23L 33/115; A23L 33/125; A23L 33/185; A23L 33/21; A23V 2002/00; A23L 33/40; A23L 33/175; A23L 2/39; A23L 2/66; A23L 25/20

(57) ABSTRACT

A fasting bar to be used for an intermittent fasting-mimicking meal includes any combination of macadamia nuts; honey; pecans; almonds; almond butter; coconut; inulin; flax seeds; coconut oil; cocoa derivatives; and coconut flour.

### CROSS-REFERENCE TO RELATED APPLICATIONS

This application claims the benefit of U.S. provisional application Ser. No. 63/105,322 filed Oct. 25, 2020 and of U.S. provisional application Ser. No. 63/038,894 filed Jun. 14, 2020, the disclosures of which are hereby incorporated in their entirety by reference herein.

### TECHNICAL FIELD

The present invention, in general, relates to a fasting bar or drink component of a fasting-mimicking diet that provides nutrients to a subject.

### BACKGROUND

Recently, fasting-mimicking diets have been found to provide a number of health benefits. For example, fasting-mimicking diets have been found to be useful in improving metabolic health including weight, age-related markers, inflammatory markers, metabolic syndrome, diabetes, and hypertension; as well as alleviating symptoms of chemotherapy, and Alzheimer's disease.

U.S. patent application Ser. No. 15/432,803 provides a diet package that is designed to provide daily food components to a subject in accordance with a fasting-mimicking diet. This diet package includes various components such as soup mixes, fasting bars, and crackers, all which mimic fasting. Although the prior art fasting-mimicking diet components work well, compositions with improved formulation and appeal taste properties are desired.

Accordingly, there is a need for novel fasting bars to be used in intermittent fasting or the fasting-mimicking diet.

### SUMMARY

In at least one aspect, a first high fat/low carb fasting bar for intermittent fasting or a fasting-mimicking diet is provided. The first high fat/low carb fasting bar includes total fat in an amount that provides from about 350 to about 700 kcal per 100 grams of fasting bar or drink/shake; optionally, saturated fats in an amount that provides from about 80 to 130 kcal of saturated fat per 100 grams of fasting bar; carbohydrates in an amount that provides from about 75 to 135 kcal per 100 grams of fasting bar; and proteins in an amount that provides from about 30 to about 60 kcal per 100 grams of fasting bar.

In another aspect, a second high fat/low carb fasting bar for intermittent fasting or a fasting-mimicking diet is provided. The second high fat/low carb fasting bar includes total fat in an amount that provides from about 250 to about 500 kcal per 100 grams of fasting bar or drink/shake; optionally, saturated fats in an amount that provides from about 25 to 70 kcal of saturated fat per 100 grams of fasting bar; carbohydrates in an amount that provides from about 100 to 160 kcal per 100 grams of fasting bar; and proteins in an amount that provides from about 30 to about 60 kcal per 100 grams of fasting bar.

In another aspect, a high fat/high carb fasting bar for intermittent fasting or a fasting-mimicking diet is provided. The fasting bar includes total fat in an amount that provides from about 130 to about 300 kcal per 100 grams of fasting bar; optionally, saturated fats in an amount that provides from about 20 to 60 kcal of saturated fat per 100 grams of fasting bar; carbohydrates in an amount that provides from about 130 to 300 kcal per 100 grams of fasting bar; and proteins in an amount that provides from about 30 to about 55 kcal per 100 grams of fasting bar.

In another aspect, a method of intermittent fasting or time restricted eating or time restricted feeding is provided. The method includes a step of fasting by a subject for 12 up to 24 hours only intaking a fasting bar for a predetermined number of meals. The fasting bar or drink/shake of this method can be any of the fasting bars or drinks set forth herein.

In another variation, a method for administering a fasting-mimicking diet is provided. The method includes a step of identifying a subject in need of a fasting-mimicking diet. The subject is then provided with a fasting-mimicking diet having less than about 10 percent calories from protein sources. The fasting-mimicking diet provides at most 50% of the normal caloric intake of the subject with at least 50% of the kilocalories being derived from fat. Characteristically, the fasting-mimicking diet includes any of the fasting bars set forth herein.

In another aspect, a drink powder composition for making a fasting drink or shake, or a ready to drink fasting drink is provided. The drink powder composition includes total fat in an amount that provides from about 300 to about 700 kcal per 100 grams of the drink powder or ready to drink composition; carbohydrates in an amount that provides from about 50 to 150 kcal per 100 grams of the drink powder or ready to drink composition; and proteins in an amount that provides from about 30 to about 60 kcal per 100 grams of the drink powder composition or ready to drink composition.

In another aspect, the fasting bar and/or the fasting drink/shake described herein can be consumed by a subject who is fasting without breaking the fasting state. Such a subject can be intermittent fasting, taking the fasting-mimicking bar or drink, or totally abstaining from food from a predetermined time interval.

In another aspect, consumption of the fasting bar and/or fasting drink with coffee and tea does not break the fasting state.

In another aspect, a subject can consume the fasting bar and/or the fasting drink described herein along with a caffeinated beverage (e.g., coffee, tea, etc.) without breaking the fasting state.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Nutritional information for an example of a fasting bar.

FIG. 2A. Nutritional information for an example of a fasting drink without nuts.

FIG. 2B. Nutritional information for an example of a fasting drink without nuts.

FIG. 2C. Nutritional information for an example of a fasting drink with nuts.

FIG. 3A. Plot of average glucose level versus time after consumption of breakfast, fasting bar, and water by a cohort of test subjects.

FIG. 3B. Scatter chart for glucose levels (i.e., area under the curve) 0 to 4 hours after consumption of breakfast, fasting bar, and water by a cohort of test subjects.

FIG. 3C. Scatter chart for glucose levels for day 1 after consumption of breakfast, fasting bar, and water by a cohort of test subjects.

FIG. 3D. Scatter chart for glucose levels for at hour 0 after consumption of breakfast, fasting bar, and water by a cohort of test subjects.

FIG. 3E. Scatter chart for glucose levels 1 hour after consumption of breakfast, fasting bar, and water by a cohort of test subjects.

FIG. 3F. Scatter chart for glucose levels 2 hours after consumption of breakfast, fasting bar, and water by a cohort of test subjects.

FIG. 3G. Scatter chart for glucose levels 3 hours after consumption of breakfast, fasting bar, and water by a cohort of test subjects.

FIG. 3H. Scatter chart for glucose levels 4 hours after consumption of breakfast, fasting bar, and water by a cohort of test subjects.

FIG. 4A. Plot of average ketone level versus time after consumption of breakfast, fasting bar, and water by a cohort of test subjects.

FIG. 4B. Scatter chart for ketone levels (i.e., area under the curve) 0 to 4 hours after consumption of breakfast, fasting bar, and water by a cohort of test subjects.

FIG. 4C. Scatter chart for ketone levels for day 1 after consumption of breakfast, fasting bar, and water by a cohort of test subjects.

FIG. 4D. Scatter chart for ketone levels for at hour 0 after consumption of breakfast, fasting bar, and water by a cohort of test subjects.

FIG. 4E. Scatter chart for ketone levels 1 hour after consumption of breakfast, fasting bar, and water by a cohort of test subjects.

FIG. 4F. Scatter chart for ketone levels 2 hours after consumption of breakfast, fasting bar, and water by a cohort of test subjects.

FIG. 4G. Scatter chart for ketone levels 3 hours after consumption of breakfast, fasting bar, and water by a cohort of test subjects.

FIG. 4H. Scatter chart for ketone levels 4 hours after consumption of breakfast, fasting bar, and water by a cohort of test subjects.

FIGS. 5A, 5B, 5C, 5D, 5E, and 5F. After a 15-hour overnight fast, study foods were consumed at hour 0 for the breakfast and Fast Bar™ groups. (a) Ketone and (d) glucose levels were measured at time 0 and hourly for 4 h. (b) Blood ketone levels 3 h after the experimental groups consumed the study foods. (c) Ketone and (f) glucose area under the curve (AUC₀₋₄) between hour 0 and 4 after the experimental groups consuming the study foods. (e) Blood glucose levels 1 h after the experimental groups consuming the study foods. Data represent mean and standard error. ** p<0.01, *** p<0.001, **** p<0.0001, Fast Bar™ or breakfast group compared to the water fast group, one-way ANOVA, with Tukey's multiple comparisons test.

FIGS. 6A, 6B, 6C, and 6D. Changes in subjective measures at 3 h post Fast Bar™ consumption: (A) “How strong is your desire to eat?”; (B) “How hungry do you feel?”; (C) “How full do you feel?”; (D) How much food do you think you could eat?”. * p<0.05, unpaired, nonparametric, one-tailed, Mann-Whitney test comparing Fasting Bar™ group to the water fast group.

FIGS. 7A and 7B. (A) Ketone and (B) glucose area under the curve (AUC₀₋₄) between hour 0 and 4 after the experimental groups consuming the study foods. Data represent mean and standard error. * p<0.05, *** p<0.001, unpaired, one-way ANOVA, with Tukey's multiple comparisons test, comparing experimental groups to the Breakfast group.

FIGS. 8A, 8B, 8C, and 8D. Subjects consumed a standardized dinner by 5 pm on day 1. Subjects continued water fast, ate a Fast Bar™ at 8 pm (Bar pm, 3h after dinner), or had a Fast bar (Bar am) or breakfast after 15-hour overnight fast. (a) Ketone and (b) glucose levels after consuming a standardized dinner by 5 pm on day 1. Baseline (BL) fasting levels of ketone and glucose were measured in the morning on day 1. (c) Ketone and (d) glucose area under the curve (AUC₀₋₄) between hour 0 and 4 after a 15-hour overnight fast and the experimental groups consuming the study foods on day 2. Data represent mean and standard error. * p<0.05, *** p<0.001, unpaired, one-way ANOVA, with Tukey's multiple comparisons test, comparing experimental groups to the Water Fast group.

FIGS. 9A, 9B, 9C, and 9D. (A) Blood ketone levels 3 hours after subjects consumed the study foods. (B) Ketone area under the curve (AUC₀₋₄) between hour 0 and 4 after the experimental groups consuming the study foods. (D) Blood glucose levels 1 hour after subjects consuming the study foods. (D) glucose AUC₀₋₄ after the experimental groups consuming the study foods. Data represent mean and standard error. * p<0.05, ** p<0.01, *** p<0.001, **** p<0.0001, FMD or breakfast group compared to the Breakfast group, one-way ANOVA, with Tukey's multiple comparisons test.

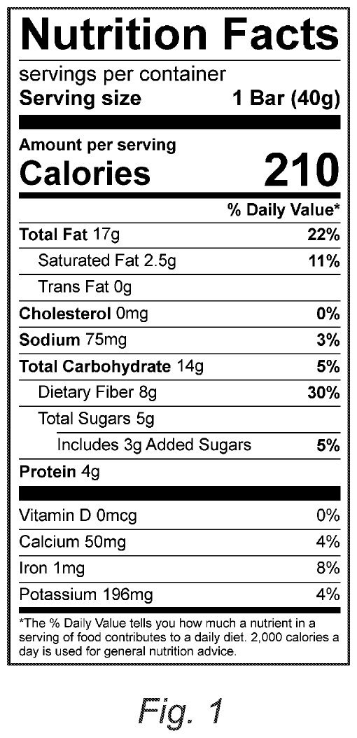

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, compositions, concentrations, amounts of diet components, and other conditions can be practiced with plus or minus 50 percent of the values indicated rounded to or truncated to two significant figures of the value provided in the examples. In a refinement, compositions, concentrations, amounts of diet components, and other conditions can be practiced with plus or minus 30 percent of the values indicated rounded to or truncated to two significant figures of the value provided in the examples. In another refinement, compositions, concentrations, amounts of diet components, and other conditions can be practiced with plus or minus 10 percent of the values indicated rounded to or truncated to two significant figures of the value provided in the examples.

The term “subject” refers to a human or animal, including all mammals such as primates (particularly higher primates), sheep, dog, rodents (e.g., mouse or rat), guinea pig, goat, pig, cat, rabbit, and cow.

The term “fasting-mimicking and enhancing diet” means a diet that mimics the effects of fasting typically by providing a subject with at most 50% of their normal caloric intake. The term “fasting-mimicking and enhancing diet” is sometimes simply referred to as a “fasting-mimicking diet.” These diets include those diets that have been referred to as fasting-mimicking diets. Examples of useful fasting-mimicking and enhancing diets and methods for monitoring the effects of these diets on markers such as IGF-1 and IGFBP1 in the context of the present invention are set forth in U.S. Pat. Pub. No. 2014/0328863 published Nov. 6, 2014; U.S. Pat. Pub. No. 2015/0133370 published May 14, 2015; U.S. Pat. Pub. No. 2011/0118528 published May 19, 2011; U.S. Pat. Pub. No. 2013/0045215 published Feb. 21, 2013; U.S. Pat. Pub. No. 2013/0316948 published Nov. 28, 2013; U.S. Pat. No. 10,015,980 issued Jul. 10, 2018; U.S. Pat. No. 9,237,761 issued Jan. 19, 2016; U.S. Pat. No. 9,386,790 issued Jul. 12, 2016; U.S. Pat. No. 10,172,839 issued Jan. 8, 2019; the entire disclosure of these patent applications is hereby incorporated by reference. The fasting-mimicking diet set forth in U.S. Pat. Nos. 10,015,980 and 9,237,761 are found to be particularly useful in the present invention.

In a refinement, the term “fasting state” means the physiological state a subject achieves after complete abstinence from calories. In another refinement, the term “fasting state” refers to the physiological state in which a subject exhibits ketones (e.g., β-hydroxybutyrate) in an amount greater than 0.3 mM/l for a period of at least one hour and a glucose level less than 100 mg/dL.

In all the compositions set forth herein, micronutrients such as vitamins and mineral are optional ingredients.

Unless stated to the contrary, amounts of ingredients for a fasting bar are for 100 g of the fasting bar.

Unless stated to the contrary, amounts of ingredients for a fasting drink are for 100 g of the fasting drink.

Unless stated to the contrary, amounts of ingredients for a fasting drink powder composition are for 100 g of the fasting drink powder composition.

Abbreviations:

“AUC” means area under the curve.

“BMI” means body mass index.

“glc” means glucose.

“SEM” means standard error of the mean.

“WF” means water fast.

Several embodiments of a fasting bar that can be used in a fasting-mimicking diet and/or for intermittent fasting or time restricted eating or time restricted feeding are provided. Sometimes, the “fasting bar” is referred to as a “fast bar.” Advantageously, these fasting bars can be used as a “fasting-mimicking meal replacement” bar or as a “fasting-mimicking” light meal’ bar that can replace breakfast, lunch or dinner or as a snack in between meals.

In one embodiment, a first high fat/low carb fasting bar is provided. Examples of the nutritional components of the first high fat/low carb nutrition are provided in Table 1. In a refinement, the components can be present in +/−30 percent of the values indicated in Table 1. Although the present variation is not limited by the serving size of the fasting bar except that the size should be sufficient to provide a predetermined number of kilocalories or fat or carbohydrates. Typically, the first high fat/low carb fasting bar is provided in an amount of 30 grams to 150 grams. Preferred sizes are 30 grams, 40 grams, 45 grams and 100 grams. In a refinement, the fasting bar includes from about 350 to about 700 kcal fat per 100 grams of fasting bar. In a refinement, the first high fat/low carb fasting bar also includes from about 80 to 130 kcal of saturated fat per 100 grams of fasting bar. In another refinement, the first high fat/low carb fasting bar also includes from about 20 to 80 kcal of saturated fat per 100 grams of fasting bar. The first high fat/low carb fasting bar also includes from about 75 to 135 kcal of carbohydrates per 100 grams of fasting bar. The first high fat/low carb fasting bar also includes from about 30 to about 60 kcal of total protein per 100 grams of fasting bar. The first high fat/low carb fasting bar optionally includes from about 2 to 18 grams of fiber per 100 grams of fasting bar. In a refinement, the first high fat/low carb fasting bar optionally includes from about 2 to 12 grams of fiber per 100 grams of fasting bar.

TABLE 1
High fat/low carb fasting
bar example 1.

| | Per | Per |
|---|---|---|
| NUTRIENTS | Serving | 100 g |
| Gram Weight (g) | 45.00 | 100 |
| Calories (kcal) | 269.12 | 598.04 |
| Calories from Fat | 208.8 | 464.00 |
| (kcal) | | |
| Calories from | 48.6 | 108.00 |
| Saturated Fat | | |
| (kcal) | | |
| Protein (g) | 4.97 | 11.04 |
| Carbohydrates (g) | 12.73 | 28.29 |
| Total Dietary Fiber | 3.37 | 7.49 |
| (g) | | |
| Total Sugars (g) | 7.75 | 17.22 |
| Added Sugar (g) | 6.54 | 14.54 |
| Fat (g) | 23.2 | 51.56 |
| Saturated Fat (g) | 5.4 | 12.00 |

In another variation, the first high fat/low carb fasting bar includes fat in an amount of at least, in increasing order of preference, 30 weight percent, 40 weight percent, 45 weight percent, or 50 weight percent and fat in an amount of at most, in increasing order of preference, 70 weight percent, 65 weight percent, 60 weight percent, or 55 weight percent. In a refinement, the first high fat/low carb fasting bar includes saturated fat in an amount of at least, in increasing order of preference, 8 weight percent, 5 weight percent, 2 weight percent, or 1 weight percent and saturated fat in an amount of at most, in increasing order of preference, 20 weight percent, 15 weight percent, 10 weight percent, or 8 weight percent. The fasting bar also includes carbohydrates in an amount of at least, in increasing order of preference, 1 weight percent, 3 weight percent, 10 weight percent, 15 weight percent, 20 weight percent, or 25 weight percent and carbohydrates in an amount of at most, in increasing order of preference, 35 weight percent, 30 weight percent, 40 weight percent, 38 weight percent, 35 weight percent, or 30 weight percent. The fasting bar also includes proteins in an amount of at least, in increasing order of preference, 1 weight percent, 2 weight percent, 3 weight percent, 5 weight percent, or 8 weight percent and protein in an amount of at most, in increasing order of preference, 20 weight percent, 18 weight percent, 17 weight percent, 16 weight percent, or 15 weight percent. Unless stated to the contrary all percentages are weight percentages of the total weight of the fasting bar.

In another variation, the first high fat/low carb fasting bar also includes from about 40 to 60 grams total fat of which 8 to 15 grams are optionally saturated fat per 100 grams of fasting bar. The fasting bar also includes from about 20 to 40 grams carbohydrates per 100 grams of fasting bar. The fasting bar also includes from about 5 to 15 grams proteins per 100 grams of fasting bar.

In other variations, the first high fat/low carb fasting bar includes fat in an amount of at least, in increasing order of preference, 10 gram, 15 grams, 20 grams, 25 grams, or 30 grams per 100 g of the fasting bar, and fat in an amount of at most, in increasing order of preference, 60 grams, 50 grams, 45 grams, 40 grams, or 35 grams per 100 g of the fasting bar. In a refinement, the first high fat/low carb fasting bar includes saturated fat in an amount of at least, in increasing order of preference, 2.5 grams, 2 grams, 1.5 grams, 1 grams, or 0.5 gram per 100 g of the fasting bar, and saturated fat in an amount of at most, in increasing order of preference, 10 grams, 8 grams, 5 grams, 4 grams, or 3 grams per 100 g of the fasting bar. The fasting bar includes carbohydrates in an amount of at least, in increasing order of preference, 5 gram, 10 grams, 15 grams, 20 grams, or 25 grams per 100 g of the fasting bar, and carbohydrates in an amount of at most, in increasing order of preference, 40 grams, 38 grams, 35 grams, 33 grams, or 30 grams per 100 g of the fasting bar. The fasting bar also includes protein in an amount of at least, in increasing order of preference, 1 gram, 2 grams, 5 grams, 8 grams, or 10 grams per 100 g of the fasting bar, and protein in an amount of at most, in increasing order of preference, 30 grams, 25 grams, 20 grams, 15 grams, or 12 grams per 100 g of the fasting bar. It should be appreciated that all of the variations and refinements set forth herein can be combined into a single fasting bar.

In another embodiment a second high fat/low carb fasting bar is provided. Representative nutritional components of the second high fat/low carb fasting bar are provided in Table 2. Tables 3 and 4 provide examples of the second high fat/low carb fasting bar for 40 g serving size and for 100 g. In a refinement, the components can be present in +/−30 percent of the values indicated in Tables 2-4. Although the present variation is not limited by the serving size of the fasting bar except that the size should be sufficient to provide a predetermined number of kilocalories or fat or carbohydrates. Typically, the fasting bar is provided in an amount of 30 grams to 150 grams. Preferred sizes are 30 grams, 40 grams, 45 grams and 100 grams. In a refinement, the second high fat/low carb fasting bar includes from about 250 to about 500 kcal fat per 100 grams of fasting bar. In a refinement, the second high fat/low carb fasting bar also includes from about 25 to 70 kcal of saturated fat per 100 grams of fasting bar. The second high fat/low carb fasting bar also includes from about 100 to 160 kcal of carbohydrates per 100 grams of fasting bar. The second high fat/low carb fasting bar also includes from about 30 to about 60 kcal of total protein per 100 grams of fasting bar. The second high fat/low carb fasting bar optionally includes from about 12 to 23 grams of fiber per 100 grams of fasting bar.

TABLE 2
Second high fat/low car fasting bar.

| Nutrients | Per 100 g |
|---|---|
| Gram Weight (g) | 100 |
| Calories (kcal) | 400-600 |
| Calories from Fat (kcal) | 300-500 |
| Calories from Saturated | 30-80 |
| Fat (kcal) | |
| Protein (g) | 4-14 |
| *Carbohydrates (g) | 30-45 |
| Dietary Fiber (2016) (g) | 15-25 |
| Total Sugars (g)** | 9-18 |
| Added Sugar (g) | 3-9 |
| Net Carbs (g) | 10-20 |
| Fat (g) | 38-48 |
| Saturated Fat (g) | 3-9 |
| Trans Fatty Acid (g) | 0.001-0.006 |
| Cholesterol (mg) | 0 |
| Vitamins | |
| Vitamin D-mcg (mcg) | 0 |
| Minerals | |
| Calcium (mg) | 100-150 |
| Iron (mg) | 1-6 |
| Potassium (mg) | 300-800 |
| Sodium (mg) | 150-250 |

TABLE 3
Second high fat/low car
fasting bar Example 1.

| | Per | Per |
|---|---|---|
| Nutrients | Serving | 100 g |
| Gram Weight (g) | 40 | 100 |
| Calories (kcal) | 206.26 | 515.65 |
| Calories from Fat (kcal) | 157.039 | 392.598 |
| Calories from Saturated | 20.577 | 51.441 |
| Fat (kcal) | | |
| Protein (g) | 4.399 | 10.998 |
| Carbohydrates (g) | 14.465 | 36.161 |
| Dietary Fiber (2016) (g) | 8.4 | 20.999 |
| Total Sugars (g) | 4.926 | 12.316 |
| Added Sugar (g) | 2.518 | 6.296 |
| Net Carbs (g) | 6.065 | 15.162 |
| Fat (g) | 17.449 | 43.622 |
| Saturated Fat (g) | 2.286 | 5.716 |
| Trans Fatty Acid (g) | 0.001 | 0.003 |
| Cholesterol (mg) | 0 | 0 |
| Vitamins | | |
| Vitamin D-mcg (mcg) | 0 | 0 |

TABLE 4
Second high fat/low carb
fasting bar Example 2

| | Per | Per |
|---|---|---|
| NUTRIENTS | Serving | 100 g |
| Gram Weight (g) | 40.00 | 100 |
| Calories (kcal) | 203.41 | 508.52 |
| Calories from Fat (kcal) | 156.03 | 390.08 |
| Calories from Saturated | 18.27 | 45.67 |
| Fat (kcal) | | |
| Protein (g) | 4.58 | 11.46 |
| Carbohydrates (g) | 13.45 | 33.63 |
| Total Dietary Fiber (g) | 7.22 | 18.06 |
| Total Soluble Fiber (g) | 0.05 | 0.13 |
| Total Sugars (g) | 4.86 | 12.16 |
| Added Sugar (g) | 2.74 | 6.85 |
| Fat (g) | 17.34 | 43.35 |
| Saturated Fat (g) | 2.03 | 5.07 |

In another variation, the second high fat/low carb fasting bar includes fat in an amount of at least, in increasing order of preference, 25 weight percent, 30 weight percent, 35 weight percent, or 40 weight percent and fat in an amount of at most, in increasing order of preference, 65 weight percent, 60 weight percent, 55 weight percent, or 50 weight percent. In a refinement, the second high fat/low carb fasting bar includes saturated fat in an amount of at least, in increasing order of preference, 8 weight percent, 5 weight percent, 2 weight percent, or 1 weight percent and saturated fat in an amount of at most, in increasing order of preference, 20 weight percent, 15 weight percent, 10 weight percent, or 8 weight percent. The fasting bar also includes carbohydrates in an amount of at least, in increasing order of preference, 1 weight percent, 3 weight percent, 10 weight percent, 15 weight percent, 20 weight percent, 25 weight percent, or 30 weight percent and carbohydrates in an amount of at most, in increasing order of preference, 55 weight percent, 50 weight percent, 45 weight percent, 40 weight percent, or 35 weight percent. The fasting bar also includes proteins in an amount of at least, in increasing order of preference, 1 weight percent, 2 weight percent, 3 weight percent, 5 weight percent, or 8 weight percent and protein in an amount of at most, in increasing order of preference, 20 weight percent, 18 weight percent, 17 weight percent, 16 weight percent, or 15 weight percent. Unless stated to the contrary all percentages are weight percentages of the total weight of the fasting bar.

In another variation, the second high fat/low car fasting bar includes from about 30 to 55 grams fat of which 2 to 8 grams are optionally saturated fat per 100 grams of fasting bar. The fasting bar also includes from about 25 to 50 grams carbohydrates per 100 grams of fasting bar. The fasting bar also includes from about 5 to 15 grams proteins per 100 grams of fasting bar.

In another variation, the second high fat/low carb fasting bar includes fat in an amount of at least, in increasing order of preference, 20 gram, 25 grams, 30 grams, 35 grams, or 40 grams per 100 g of the fasting bar, and fat in an amount of at most, in increasing order of preference, 65 grams, 60 grams, 55 grams, 50 grams, or 45 grams per 100 g of the fasting bar. In a refinement, the second high fat/low carb fasting bar includes saturated fat in an amount of at least, in increasing order of preference, 2.5 grams, 2 grams, 1.5 grams, 1 grams, or 0.5 gram grams per 100 g of the fasting bar, and saturated fat in an amount of at most, in increasing order of preference, 10 grams, 8 grams, 5 grams, 4 grams, or 3 grams per 100 g of the fasting bar. The fasting bar includes carbohydrates in an amount of at least, in increasing order of preference, 10 gram, 15 grams, 20 grams, 25 grams, or 30 grams per 100 g of the fasting bar, and carbohydrates in an amount of at most, in increasing order of preference, 55 grams, 50 grams, 45 grams, 40 grams, or 35 grams per 100 g of the fasting bar. The fasting bar also includes protein in an amount of at least, in increasing order of preference, 1 gram, 2 grams, 5 grams, 8 grams, or 10 grams per 100 g of the fasting bar, and protein in an amount of at most, in increasing order of preference, 30 grams, 25 grams, 20 grams, 15 grams, or 12 grams per 100 g of the fasting bar. It should be appreciated that all of the variations and refinements set forth herein can be combined into a single fasting bar.

In another embodiment, a high fat/high carb fasting bar is provided. Representative nutritional components of the second high fat/low carb fasting bar are provided in Table 5. An example of the nutritional components of the fasting bar for 23 g serving size, 40 g serving size, and for 100 g is provided in Table 6. In a refinement, the components can be present in +/−30 percent of the values indicated in Tables 5 and 6. Although the present variation is not limited by the serving size of the fasting bar except that the size should be sufficient to provide a predetermined number of kilocalories or fat or carbohydrates. Typically, the fasting bar is provided in an amount of 30 grams to 150 grams. Preferred sizes are 30 grams, 40 grams, 45 grams and 100 grams. In a refinement, the high fat/high carb fasting bar includes from about 130 to about 300 kcal fat per 100 grams of fasting bar. In a refinement, the high fat/high carb fasting bar also includes from about 20 to 60 kcal of saturated fat per 100 grams of fasting bar. The high fat/high carb fasting bar also includes from about 130 to 300 kcal of carbohydrates per 100 grams of fasting bar. The high fat/high carb fasting bar also includes from about 30 to about 55 kcal of total protein per 100 grams of fasting bar. The high fat/high carb fasting bar optionally includes from about 16 to 30 grams of fiber per 100 grams of fasting bar.

TABLE 5
High fat/high carb fasting bar

| | Weight |
|---|---|
| NUTRIENTS | percent |
| Calories (kcal) | 300-600 |
| Calories from | 120-225 |
| Fat (kcal) | |
| Calories from | 20-40 |
| Saturated Fat | |
| (kcal) | |
| Protein (g) | 3-15 |
| Carbohydrates (g) | 40-70 |
| Total Dietary Fiber | 10-30 |
| (g) | |
| Total Sugars (g) | 5-20 |
| Fat (g) | 10-30 |
| Saturated Fat (g) | 2-6 |

TABLE 6
High fat/high carb fasting bar example

| | Per | Per | Per |
|---|---|---|---|
| NUTRIENTS | Serv. | 40 g | 100 g |
| Gram Weight (g) | 23.00 | 40.00 | 100.00 |
| Calories (kcal) | 87.78 | 152.66 | 381.65 |
| Calories from Fat | 40.41 | 70.28 | 175.70 |
| (kcal) | | | |
| Calories from | 7.38 | 12.83 | 32.09 |
| Saturated fat | | | |
| (kcal) | | | |
| Protein (g) | 2.19 | 3.81 | 9.52 |
| Carbohydrates (g) | 13.49 | 23.46 | 58.65 |
| Total Dietary | 5.33 | 9.27 | 23.17 |
| Fiber (g) | | | |
| Total Sugars (g) | 3.26 | 5.67 | 14.17 |
| Fat (g) | 4.49 | 7.81 | 19.52 |
| Saturated Fat (g) | 0.82 | 1.43 | 3.57 |

In another variation, the high fat/high carb fasting bar includes fat in an amount of at least, in increasing order of preference, 5 weight percent, 10 weight percent, 15 weight percent, or 18 weight percent and fat in an amount of at most, in increasing order of preference, 35 weight percent, 30 weight percent, 25 weight percent, or 20 weight percent. The fasting bar also includes carbohydrates in an amount of at least, in increasing order of preference, 1 weight percent, 3 weight percent, 35 weight percent, 40 weight percent, 45 weight percent, 50 weight percent, or 55 weight percent and carbohydrates in an amount of at most, in increasing order of preference, 40 weight percent, 70 weight percent, 68 weight percent, 65 weight percent, or 60 weight percent. The fasting bar also includes proteins in an amount of at least, in increasing order of preference, 1 weight percent, 2 weight percent, 3 weight percent, 5 weight percent, or 8 weight percent and protein in an amount of at most, in increasing order of preference, 20 weight percent, 18 weight percent, 17 weight percent, 16 weight percent, or 15 weight percent. Unless stated to the contrary all percentages are weight percentages of the total weight of the fasting bar.

In another variation, the high fat/high carb fasting bar also includes from about 15 to 35 grams fat of which 1 to 5 grams are optionally saturated fat per 100 grams of fasting bar. The fasting bar also includes from about 40 to 70 grams carbohydrates per 100 grams of fasting bar. The fasting bar also includes from about 5 to 15 grams proteins per 100 grams of fasting bar.

In another variation, the high fat/high carb fasting bar includes fat in an amount of at least, in increasing order of preference, 10 gram, 12 grams, 15 grams, 18 grams, or 20 grams per 100 g of the fasting bar, and fat in an amount of at most, in increasing order of preference, 40 grams, 35 grams, 30 grams, 25 grams, or 22 grams per 100 g of the fasting bar. In a refinement, the high fat/high carb fasting bar includes saturated fat in an amount of at least, in increasing order of preference, 2.5 grams, 2 grams, 1.5 grams, 1 grams, or 0.5 gram grams per 100 g of the fasting bar, and saturated fat in an amount of at most, in increasing order of preference, 10 grams, 8 grams, 5 grams, 4 grams, or 3 grams per 100 g of the fasting bar. The fasting bar includes carbohydrates in an amount of at least, in increasing order of preference, 40 gram, 45 grams, 50 grams, 55 grams, or 58 grams, and carbohydrates in an amount of at most, in increasing order of preference, 75 grams, 70 grams, 65 grams, 62 grams, or 60 grams per 100 g of the fasting bar. The fasting bar also includes protein in an amount of at least, in increasing order of preference, 1 gram, 2 grams, 5 grams, 8 grams, or 10 grams, and protein in an amount of at most, in increasing order of preference, 30 grams, 25 grams, 20 grams, 15 grams, or 12 grams. It should be appreciated that all of the variations and refinements set forth herein can be combined into a single fasting bar.

In some variations of the fasting bar set forth herein, the dietary requirements of Tables 1-6 are meet by forming the bars as any combination of or all of the following components: avocado, macadamia nuts, honey, almond flour (blanched), almond meal (w/ skins), pecans, coconut, almond butter, coconut flour, inulin, flaxseed, coconut oil, natural flavor, sea salt, rosemary extract, mixed tocopherols, sunflower lecithin, citric acid, ascorbic acid, coconut palm sugar, cane sugar, olive oil/chickpea blend, fruit & vegetable blend (30% dv), acacia, guar & xanthan gum blend, and unsweetened almond milk. In a refinement, the fasting bar includes any 3, 4, 5, 6, 7, 8, 9 or 10 of these components. The fasting bar (and the fasting drink) can include any combination of or all of these components to meet the total number of calories specified, calories from fat, calories from fat saturated fat, grams of protein, grams of carbohydrates, grams of total dietary fiber, grams of total sugars, grams of fat, and grams of saturated fat (g) set forth herein for the fasting bar and the fasting drink in the table and description. In a variation, the fasting bar includes any combination of or all of: macadamia nuts; pecans; almonds; almond meal; almond butter (formed from raw or dried onions); coconut; inulin; flax seeds; cocoa derivatives; and coconut flour. In a variation, the fasting bar any combination of or all of: macadamia nuts; honey; pecans; almonds or almond meal; almond butter; inulin; flax seeds or flaxseed meal; and coconut flour. In a refinement, the fasting bar further includes coconuts and/or coconut oil. In a further refinement, the fasting bar further includes cocoa derivatives. It should be appreciated that the recitation of each component includes part of such components that can be ground, chopped, and/or dried. For examples, the recitation of macadamia nuts; honey; pecans; almonds; coconut; and flax seeds include parts of such components, i.e., nuts and cocoanuts without the shells. The fats used for the fasting bar variations includes midchain triglycerides and/or monosaturated fat and/or and polyunsaturated fat. Suitable sources of monosaturated fat, but are not limited to, peanut butter, olives, nuts (e.g., almonds, pecans, pistachios, cashews), avocado, seeds (e.g., sesame), oils (e.g., olive, sesame, peanut, canola), etc. Suitable sources of polyunsaturated fat include, but are not limited to, walnuts, seeds (e.g., pumpkin, sunflower), flaxseed, and oils (e.g., safflower, soybean, corn).

Table 7 provides an example of the components for a fasting bar composition. Typically, the ranges set forth in Table 7 can be extended by 30 percent.

TABLE 7
Example of fasting bar composition

| Ingredient | Weight Percent Range |
|---|---|
| Macadamia nuts | 17.0-22 |
| Honey | 7-10 |
| Almond flour (blanched) | 14-16.5 |
| Pecans | 16-19 |
| Almond butter | 9-13 |
| Coconut flour | 6-9 |
| Inulin | 14-18 |
| Flaxseed | 2-6 |
| Natural flavor | 0.4-1.5 |
| Sea salt | 0.1-0.5 |
| Rosemary extract | 0.02-0.1 |

Typically, the almond meal and/or the other nut components can be roasted (e.g., in a convection oven). In a refinement, the cocoa derivates include cocoa mass, cocoa powder, cocoa butter, cocoa nibs, and combinations thereof. In a refinement, the fasting bar includes a component selected from the group consisting of oleoresin, rosemary, flavor additives (e.g., vanilla powder, lemon, berry etc.), and combinations thereof. In a refinement, each fasting bar provides from 80 to 300 kcal. In a further refinement, each fasting bar provides from 100 to 300 kcal. Characteristically, the fasting bar provides 15 to 38 weight percent of the daily recommended dietary value (e.g., the nutritional requirements based on a 2000 kcal per day diet used by the United Kingdom Department of Health and the European Union's European Food Safety Authority on Nov. 1, 2019) of fat and 1 to 10 weight percent kcal of the daily recommended dietary value for carbohydrates. In a refinement, the fasting bar provides 25 to 38 weight percent of the daily recommended dietary value of fat and 1 to 10 weight percent kcal of the daily recommended dietary value for carbohydrates.

In a variation, the fasting bars further can further includes salt (e.g., sea salt). Sea salt refers to the salt obtained from the evaporation of seawater. The principal component of sea salt is sodium chloride less than 0.2 to 10% of other salts such as calcium, potassium, and magnesium salts of chloride and sulfate. In a refinement, the fasting bars further may, or may not, include coconut oil. Characteristically, the components of the fasting bar are held together by thick viscous liquid components such as the inulin, almond butter, honey, and coconut. In this regard, the almond butter is the most viscous component (e.g., an almond butter paste) thereby providing most of the cohesion of the components together. In a refinement, the fasting bars further include flavoring, mixed tocopherols, citric acid anhydrous, and ascorbic acid. In a refinement, the composition of the fasting bar includes only natural components. Moreover, the ingredients can be ground, chopped, and/or dried to form a bar with a smooth palatable form.

The fasting bar is formulated to mimic fasting to improve metabolic health related to body mass index (BMI), cholesterol, and glycemic index in the blood. The fasting bar is formulated to simulate one or more meals per day as part of an intermittent fasting-mimicking diet. The fasting bar may be used in conjunction with the practice of time restricted feeding (also known as time restricted eating). Time restricted feeding has been shown to have many health benefits including improving insulin sensitivity, blood pressure, and oxidative stress. See e.g. Sutton et al., Cell Metabolism 27, 1212-1221, Jun. 5, 2018; Amandine et al, Cell Metab., 20(6): 991-1005, 2014 Dec. 2; Longo, Cell Metab. 23(6):1048-1059, Jun. 14, 2016; Shubhroz, Cell Metab, 22(5): 789-798, Nov. 3, 2015. The fasting bar allows an individual to extend overnight fasting without the health risks of skipping breakfast. See e.g. Sharma K et al., QJM, 111(10):715-719, 2018 Oct. 1; Peñalvo et al., JACC, 70(15):1833-1842, 2017 Oct. 10; the entire disclosures of these publications are hereby incorporated by reference.

The fasting bar also complements daily nutrition of an individual. The fasting bar is preferably consumed as a meal or snack. The individual consumes the meal once or twice or three times per day when practicing time restricted feeding. In general, an individual will eat the fasting bar to achieve 12, 18 or 24-hours of intermittent fasting. Time restricted feed compresses the amount of time that an individual consumes calories and increases the amount of time an individual spends fasting. After consumption, the fasting bar keeps the subject in a fasted state, extends a subject's fast such that the subject does not break the fast in between meals thereby allowing the subject to fast with food or fast for longer or curb hunger while they fast. In a refinement, the fasting bar does not break the fast over night when consumed in the evening. In this regard, the fast may be part of a fasting-mimicking diet protocol or intermittent fasting.

In another embodiment, the fasting bar may be manufactured by weighing and pre-mixing (if required) all raw ingredients. Ingredients are placed in a large container and blended to ensure consistent mixing. Once ingredients are mixed, the blend is pressed and compressed (slabbed) to form a flat sheet of the mixed ingredients. In a refinement, the ingredients will adhere together and can at least partially react with each other. The sheet of mixed ingredients is then cut into predetermined sizes and allowed to dry to form a completed fasting bar. The fasting bar may then be packaged in foil sleeves and sealed via cold or heat sealing.

As set forth above, the fasting bar is advantageously integrated into a fasting-mimicking diet as set forth in U.S. Pat. Pub. No. 2018/0228198 published Aug. 16, 2018, the entire disclosure of which is hereby incorporated by reference. Typically, a diet package for administering a fasting-mimicking diet is provided that can include the fasting bar set forth above in place of the fasting bar set forth therein. The fasting-mimicking diet package provides daily meal portions for a predetermined number of days. Typically, the predetermined number of days is from 1 to 10 days (i.e., 1, 2, 3, 4, 5, 6, 7, 8, 9, or 10 days). In a particularly useful variation, the predetermined number of days is 5 or 6 days. In some variations, the fasting-mimicking diets set forth herein provide a subject at most, in increasing order of preference, 75%, 50%, 40%, 30%, or 10% of the subject's normal caloric intake or the daily recommended caloric intake for a subject. In a refinement, the fasting-mimicking diet provides at least, in increasing order of preference, 5%, 10%, or 20% of the subject's normal caloric intake or the daily recommended caloric intake for a subject. However, if the fasting-mimicking diet composition is maintained, based on our current and previous findings, partial disease prevention and treatment effects are anticipated even if 100% of the normal caloric intake is provided to subjects. The subject's normal caloric intake is the number of kcal that the subject consumes to maintain his/her weight. The subject's normal caloric intake may be estimated by interviewing the subject or by consideration of a subject's weight. As a rough guide, subject's normal caloric intake is on average 2600 kcal/day for men and 1850 kcal/day for women. In certain instances, the fasting-mimicking diet provides the subject with 700 to 1200 kcal/day. In a particularly useful refinement, the fasting-mimicking diet provides a male subject of average weight with about 1100 kcal/day and a female subject of average weight with 900 kcal/day. In some variation, the diet from the diet package is administered on consecutive days. In another variation, the daily meal portions are provided for only one day a week for at least a month. The fasting mimicking diet allows the subject to fast with food and receive many of the benefits of a prolonged fast, such as metabolic health, cellular autophagy, weight loss of visceral fat, an improved relationship with food or reduced food cravings, increased energy and mental clarity to name a few.

In one embodiment, as set forth above, the fasting-mimicking diet package provides daily meal portions for a predetermined number of days. The fasting-mimicking diet package includes a kale cracker composition, a first vegetable soup composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals. In a refinement, the fasting-mimicking diet package further includes a fasting bar as set forth above (e.g. a cocoa-containing fasting bar), a first olive-containing composition, a first vegetable broth composition, a tea composition that includes spearmint, an energy drink composition, a micro-nutritional composition, and algal oil composition. In a further refinement, the fasting-mimicking diet package further includes a second olive-containing composition, a second vegetable broth composition, a tea composition that includes spearmint, lemon peel and lemongrass, and a tea composition that includes hibiscus.

In a variation of the embodiments set forth above, the fasting-mimicking diet package includes daily meal portions that provide less than 40 grams of sugar for day 1, less than 30 grams of sugar for days 2 to 5 and any remaining days, less than 28 grams of protein for day 1, less than 18 grams of protein for days 2 to 5 and any remaining days, optionally 20-30 grams of monounsaturated fats or more to reach the desired caloric intake (i.e., a predetermined caloric intake) for day 1, 6-10 grams of polyunsaturated fats or more to reach the desired caloric intake for day 1, optionally 2-12 grams of saturated fats or more to reach the desired caloric intake for day 1, optionally 10-15 grams of monounsaturated fats or more to reach the desired caloric intake for days 2 to 5 and any remaining days, 3-5 grams of polyunsaturated fats or more to reach the desired caloric intake for days 2 to 5 and any remaining days, optionally 1-6 grams of saturated fats or more to reach the desired caloric intake for days 2 to 5, or any remaining days, and a micronutrient composition on each day and any remaining days.

In another variation of the embodiments set forth above, the fasting-mimicking diet package includes daily meal portions which provide 8-10 kcal per kilogram body weight for each diet day. In this variation, the fasting-mimicking diet provides less than 30 grams of sugar for each diet day, less than 18 grams of protein for each diet day, optionally 9-15 grams of monounsaturated fats or more to reach the desired caloric intake for each diet day, and 2.5-4.5 grams of polyunsaturated fats or more to reach the desired caloric intake for each diet day and optionally 1-5.5 grams of saturated fats or more to reach the desired caloric intake for each diet day. Higher levels of the fats listed above can be provided for higher FMD formulation providing up to 100% of the normal caloric intake to subjects.

In another variation, a method for administering a fasting-mimicking diet is provided. The method includes a step of identifying a subject in need of a fasting-mimicking diet. A subject in need of the fasting-mimicking diet may have diabetes, metabolic syndrome, diabetes, and hypertension, and/or Alzheimer's disease. Additional subject in need of the fasting-mimicking diet may be obese subjects in need of weight reduction or adjustment of their lipid panels or subjects having cancer and undergoing chemotherapy. The subject is then provided with a fasting-mimicking diet having less than about 10 percent calories from protein sources. In a refinement, the fasting-mimicking diet is provided in the form of a diet package as set forth above. The fasting-mimicking diet provides at most 50% of the normal caloric intake of the subject with at least 50% of the kilocalories being derived from fat. Characteristically, the fasting-mimicking diet includes a fasting bar as set forth above. As set forth above, the fasting bar includes any combination of macadamia nuts; honey; pecans; almonds; almond butter; coconut; inulin; cocoa derivatives; flax seeds; and coconut flour. Characteristically, the fasting bar provides from 100 to 300 kcal of which 40 percent kcal are from fats and 10 to 30 percent kcal are from carbohydrates with less than 10 grams of protein. In a refinement, the fasting-mimicking diet provides the subject with from about 300 to 1200 kcal per day. In another refinement, the method further includes a step of monitoring glucose and/or IGF-1 levels of the subject.

Advantageously, the fasting-mimicking diet allows the subject to fast with food and receive many benefits of a prolonged fast, such as metabolic health, cellular autophagy, weight loss of visceral fat, an improved relationship with food or reduced food cravings, increased energy and mental clarity.

In a refinement, the fasting-mimicking diet is administered to the subject for a first time period from 1 day to 14 days (i.e., 1, 2, 3, 4, 5, 6, 7, 8, 9, 10, 11, 12, 13, or 14 days).

In some refinements, the fasting-mimicking diet provides from 3 to 7 kilocalories per pound of the subject for each day of the fasting-mimicking diet. In a further refinement, the fasting-mimicking diet provides from 4.5 to 7 kilocalories per pound of the subject on day 1 of the fasting-mimicking diet and 3-5 kilocalories per pound of the subject on each of the other days of the fasting-mimicking diet.

Typically, the method further includes a step of administering a second diet to the subject for a second time period following the low protein diet wherein the second diet provides an overall calorie consumption that is within 20 percent of a subject's normal calorie consumption for 25 to 26 days.

In another embodiment, a fasting drink is provided. The fasting drink is typically formed from a fasting drink powder composition which is dissolved in water. In a refinement, the fasting drink and/or the fasting drink powder composition includes total fat in an amount that provides from about 200 to about 600 kcal per 100 grams of the fasting drink and/or the fasting drink powder composition; saturated fat in an amount from about 40 to 70 kcal per 100 grams of the fasting drink and/or the fasting drink powder composition; carbohydrates in an amount that provides from about 100 to 200 kcal per 100 grams of the fasting drink and/or the fasting drink powder composition; and proteins in an amount that provides from about 30 to about 60 kcal per 100 grams of the fasting drink and/or the fasting drink powder composition. In some variations, the drink powder composition has the same nutritional ranges (e.g., calories and ingredients) as set forth above for the fasting bar with the components be formed into a form (e.g., powder) suitable to be combined with a liquid carrier to form a drink.

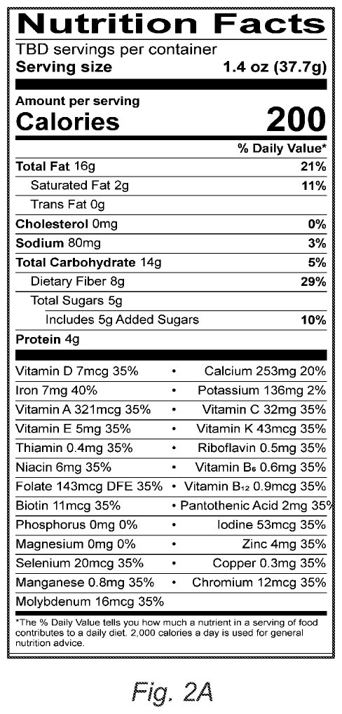

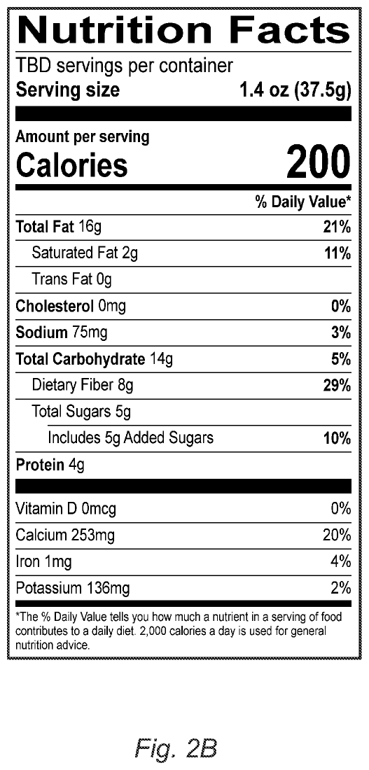

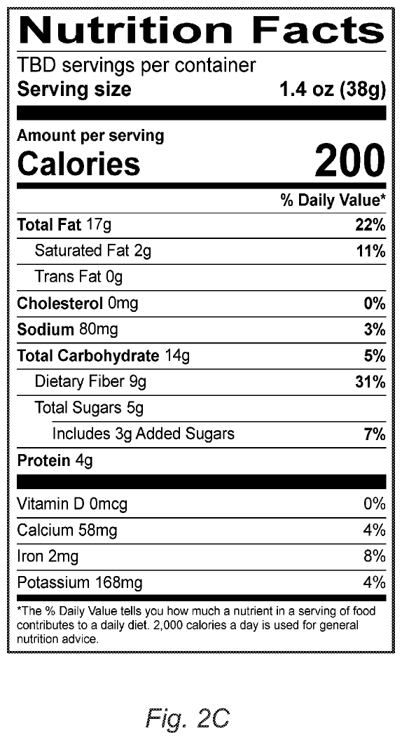

FIGS. 2A and 2B provide the nutritional components and micronutrients for one example of a nut-free drink powder composition and the ready to drink fasting drink composition (without the liquid carrier component). Representative macronutrients for the nut-free drink powder composition are provided in Table 8. Table 9 provides a specific example of the nut-free drink powder composition. Variations of the drink powder composition can be in the range from plus or minus 30 percent of the values indicated in Tables 8 and 9. It should be appreciated that the vitamins and minerals are optional ingredients. The ready to drink fasting drink composition can includes the same ingredients as indicated in Tables 8 and 9 excluding the liquid carrier. This drink powder composition can be formed from any combination of or all of the following ingredients: extra virgin olive oil, chickpea protein concentrate, cane sugar, natural flavor, gum blend (guar gum, gum acacia, xanthan gum), vegetable blend (broccoli, spinach, kale, pumpkin, sweet potato, sunflower seed, cranberry, chlorella, maitake mushroom and shitake mushroom), medium chain triglycerides, and combinations thereof. In a variation, the olive oil is provided in the form a powder by forming an olive oil and chickpea blend. In a refinement, powderized olive oil includes olive oil micronized and spray-dried on a chickpea, maltodextrin (e.g., tapioca maltodextrin), or other starches, or combinations thereof.

TABLE 8
Nut Free Drink.

| Nutrients | Per 100 g |
|---|---|
| Gram Weight (g) | 100 |
| Calories (kcal) | 400-600 |
| Calories from Fat (kcal) | 300-500 |
| Calories from Saturated | 30-80 |
| Fat (kcal) | |
| Protein (g) | 4-14 |
| Carbohydrates (g) | 30-45 |
| Dietary Fiber (2016) (g) | 15-25 |
| Total Sugars (g) | 9-18 |
| Added Sugar (g) | 9-18 |
| Net Carbs (g) | 13-23 |
| Fat (g) | 38-48 |
| Saturated Fat (g) | 2-8 |
| Trans Fatty Acid (g) | 0.05-0.5 |
| Cholesterol (mg) | 0-0.01 |
| Vitamins | |
| Vitamin D-mcg (mcg) | 0 |
| Minerals | |
| Calcium (mg) | 200-800 |
| Iron (mg) | 10-30 |
| Potassium (mg) | 250-500 |
| Sodium (mg) | 100-300 |

TABLE 9
Example of a fasting drink without nuts.

| Ingredient | Weight Percent Range |
|---|---|
| Natural flavor | 0.80-1.2 |
| Sea salt | 0.3-0.8 |
| Cane Sugar | 10-15 |
| Olive Oil/Chickpea blend | 70-90 |
| Fruit & Veggie blend | 0.2-1 |
| (30% DV) | |
| Acacia, Guar & Xanthan | 0.5-3 |
| gum blend | |

FIG. 2C provides the nutritional components and micronutrients for one example of a powder composition for the fasting drink and the ready-to-drink fasting drink composition (without the liquid carrier component). Representative macronutrients for the nut-free drink powder composition are provided in Table 10. Table 11 provides a specific example of the nut-free drink powder composition. Variations of the drink powder composition can be in the range from plus or minus 30 percent of the values indicated in Tables 10 and 11. The ready-to-drink fasting drink composition can include the same ingredients as indicated in Tables 10 and 11, excluding the liquid carrier. It should be appreciated that the minerals are optional ingredients. Variations of the powder can be in the range from plus or minus 30 percent of the values indicated. This drink powder composition can be formed from any combination of or all of the following ingredients: macadamia nuts, almond flour (blanched), pecans, coconut flour, inulin, flaxseed, natural flavor, sea salt, rosemary extract, coconut palm sugar, extra virgin olive oil, chickpea protein concentrate, coconut palm sugar, vanilla, gum blend (guar gum, gum acacia, xanthan gum), tricalcium phosphate, vegetable blend (broccoli, spinach, kale, pumpkin, sweet potato, sunflower seed, cranberry, chlorella, maitake mushroom and shitake mushroom), medium-chain triglycerides, and combinations thereof.

TABLE 10
Nut-containing Drink.

| Nutrients | Per 100 g |
|---|---|
| Gram Weight (g) | 100 |
| Calories (kcal) | 400-600 |
| Calories from Fat (kcal) | 300-500 |
| Calories from Saturated | 30-80 |
| fat (kcal) | |
| Protein (g) | 4-14 |
| Carbohydrates (g) | 30-45 |
| Dietary Fiber (2016) (g) | 15-25 |
| Total Sugars (g) | 9-18 |
| Added Sugar (g) | 6-12 |
| Net Carbs (g) | 10-20 |
| Fat (g) | 38-48 |
| Saturated Fat (g) | 3-9 |
| Trans Fatty Acid (g) | 0.0005-0.006 |
| Cholesterol (mg) | 0 |
| Vitamins | |
| Vitamin D-mcg (mcg) | 0 |
| Minerals | |
| Calcium (mg) | 100-200 |
| Iron (mg) | 1-6 |
| Potassium (mg) | 300-800 |
| Sodium (mg) | 150-250 |

TABLE 11
Example of a fasting drink with nuts

| Ingredient | Weight Percent Range |
|---|---|
| Macadamia nuts | 17-23 |
| Almond flour (blanched) | 15-25 |
| Pecans | 18-25 |
| Coconut flour | 3-8 |
| Inulin | 10-16 |
| Flaxseed | 5-9 |
| Natural flavor | 0.1-4 |
| Sea salt | 0.1-0.7 |
| Rosemary extract | 0.01-0.1 |
| Coconut Palm Sugar | 8-13 |

A user forms the fasting drink by adding the drink powder composition to water, unsweetened almond milk, or another low calorie beverage with mixing. Typically, the low calorie beverage provides less than 20 kilocalories. In a refinement, the low calorie beverage provides less than 10 kilocalories. In a refinement, the powder is added to a caffeinated beverage such as tea or coffee. The fasting drink powder composition can be formed from its ingredients by grinding, blending powder components, spray drying, freeze-drying, and combinations thereof. Therefore, the fasting drink and the fasting drink powder composition can have the same nutritional ingredients and properties.

In another variation, the fasting drink and/or the fasting drink powder composition includes fat in an amount of at least, in increasing order of preference, 30 weight percent, 40 weight percent, 45 weight percent, or 50 weight percent and fat in an amount of at most, in increasing order of preference, 70 weight percent, 65 weight percent, 60 weight percent, or 55 weight percent. In a refinement, the fasting drink and/or the fasting drink powder composition includes saturated fat in an amount of at least, in increasing order of preference, 8 weight percent, 5 weight percent, 2 weight percent, or 1 weight percent and saturated fat in an amount of at most, in increasing order of preference, 20 weight percent, 15 weight percent, 10 weight percent, or 8 weight percent. The fasting drink and/or the fasting drink powder composition also includes carbohydrates in an amount of at least, in increasing order of preference, 1 weight percent, 3 weight percent, 10 weight percent, 15 weight percent, 20 weight percent, or 25 weight percent and carbohydrates in an amount of at most, in increasing order of preference, 35 weight percent, 30 weight percent, 40 weight percent, 38 weight percent, 35 weight percent, or 30 weight percent. The fasting drink and/or the fasting drink powder composition also includes proteins in an amount of at least, in increasing order of preference, 1 weight percent, 2 weight percent, 3 weight percent, 5 weight percent, or 8 weight percent and protein in an amount of at most, in increasing order of preference, 20 weight percent, 18 weight percent, 17 weight percent, 16 weight percent, or 15 weight percent. Unless stated to the contrary all percentages are weight percentages of the total weight of the fasting drink and/or the fasting drink powder composition. The fats used for the fasting drink and/or the fasting drink powder composition includes midchain triglycerides and/or monosaturated fat and/or and polyunsaturated fat. Suitable sources of monosaturated fat, but are not limited to, peanut butter, olives, nuts (e.g., almonds, pecans, pistachios, cashews), avocado, seeds (e.g., sesame), oils (e.g., olive, sesame, peanut, canola), etc. Suitable sources of polyunsaturated fat include, but are not limited to, walnuts, seeds (e.g., pumpkin, sunflower), flaxseed, and oils (e.g., safflower, soybean, corn).

In another variation, the fasting drink and/or the fasting drink powder composition includes from about 40 to 60 grams total fat of which 8 to 15 grams are optionally saturated fat per 100 grams of fasting drink and/or fasting drink powder composition respectively. The fasting drink and/or fasting drink powder composition also includes from about 20 to 40 grams carbohydrates per 100 grams of fasting drink and/or the fasting drink powder composition, respectively. The fasting drink and/or fasting drink powder composition, also includes from about 5 to 15 grams proteins per 100 grams of fasting drink and/or fasting drink powder composition, respectively.

In other variations, the fasting drink and/or the fasting drink powder composition includes fat in an amount of at least, in increasing order of preference, 10 gram, 15 grams, 20 grams, 25 grams, or 30 grams, and fat in an amount of at most, in increasing order of preference, 60 grams, 50 grams, 45 grams, 40 grams, or 35 grams per 100 g of the fasting drink and/or the fasting drink powder composition, respectively. In a refinement, the fasting drink and/or the fasting drink powder composition includes saturated fat in an amount of at least, in increasing order of preference, 2.5 grams, 2 grams, 1.5 grams, 1 grams, or 0.5 gram grams per 100 g of the fasting drink and/or the fasting drink powder composition, respectively, and saturated fat in an amount of at most, in increasing order of preference, 10 grams, 8 grams, 5 grams, 4 grams, or 3 grams per 100 g of the fasting drink and/or the fasting drink powder composition, respectively. The fasting drink and/or the fasting drink powder composition includes carbohydrates in an amount of at least, in increasing order of preference, 5 gram, 10 grams, 15 grams, 20 grams, or 25 grams, and carbohydrates in an amount of at most, in increasing order of preference, 40 grams, 38 grams, 35 grams, 33 grams, or 30 grams per 100 g of the fasting drink and/or the fasting drink powder composition, respectively. The fasting drink and/or the fasting drink powder composition also includes protein in an amount of at least, in increasing order of preference, 1 gram, 2 grams, 5 grams, 8 grams, or 10 grams, and protein in an amount of at most, in increasing order of preference, 30 grams, 25 grams, 20 grams, 15 grams, or 12 grams per 100 g of the fasting drink and/or the fasting drink powder composition, respectively. It should be appreciated that all of the variations and refinements set forth herein can be combined into a single fasting drink or fasting drink powder composition.

In another variation, the fasting drink and/or the fasting drink powder composition includes fat in an amount of at least, in increasing order of preference, 5 weight percent, 10 weight percent, 15 weight percent, or 18 weight percent and fat in an amount of at most, in increasing order of preference, 35 weight percent, 30 weight percent, 25 weight percent, or 20 weight percent. The fasting drink and/or fasting drink powder composition also includes carbohydrates in an amount of at least, in increasing order of preference, 1 weight percent, 3 weight percent, 35 weight percent, 40 weight percent, 45 weight percent, 50 weight percent, or 55 weight percent and carbohydrates in an amount of at most, in increasing order of preference, 40 weight percent, 70 weight percent, 68 weight percent, 65 weight percent, or 60 weight percent. The fasting drink and/or fasting drink powder composition also includes proteins in an amount of at least, in increasing order of preference, 1 weight percent, 2 weight percent, 3 weight percent, 5 weight percent, or 8 weight percent and protein in an amount of at most, in increasing order of preference, 20 weight percent, 18 weight percent, 17 weight percent, 16 weight percent, or 15 weight percent. Unless stated to the contrary all percentages are weight percentages of the total weight of the fasting drink or fasting drink powder composition.

In another variation, the fasting drink and/or the fasting drink powder also includes from about 15 to 35 grams fat of which 1 to 5 grams are optionally saturated fat per 100 grams of fasting drink and/or the fasting drink powder. The fasting drink and/or the fasting drink powder also includes from about 40 to 70 grams carbohydrates per 100 grams of fasting drink and/or the fasting drink powder. The fasting drink and/or fasting drink powder composition also includes from about 5 to 15 grams proteins per 100 grams of fasting drink and/or the fasting drink powder.

In another variation, the fasting drink and/or the fasting drink powder includes fat (e.g., total fat) in an amount of at least, in increasing order of preference, 10 gram, 12 grams, 15 grams, 18 grams, or 20 grams, and fat in an amount of at most, in increasing order of preference, 40 grams, 35 grams, 30 grams, 25 grams, or 22 grams per 100 g of the fasting drink and/or the fasting drink powder. The fasting drink and/or the fasting drink powder includes carbohydrates in an amount of at least, in increasing order of preference, 40 gram, 45 grams, 50 grams, 55 grams, or 58 grams, and carbohydrates in an amount of at most, in increasing order of preference, 75 grams, 70 grams, 65 grams, 62 grams, or 60 grams per 100 g of the fasting drink and/or the fasting drink powder. The fasting drink and/or the fasting drink powder also includes protein in an amount of at least, in increasing order of preference, 1 gram, 2 grams, 5 grams, 8 grams, or 10 grams, and protein in an amount of at most, in increasing order of preference, 30 grams, 25 grams, 20 grams, 15 grams, or 12 grams per 100 g of the fasting drink and/or the fasting drink powder. It should be appreciated that all of the variations and refinements set forth herein can be combined into a single fasting drink.

In another embodiment, a method for extending a fast with the fasting bar and/or fasting drink set forth herein is provided. The method includes a step of providing a fasting bar and/or fast to a subject for extending a fasting state. As set forth above, the fasting bar includes total fat in an amount that provides from about 350 to about 700 kcal per 100 grams of the fasting bar; carbohydrates in an amount that provides from about 75 to 135 kcal per 100 grams of the fasting bar; and proteins in an amount that provides from about 30 to about 60 kcal per 100 grams of the fasting bar. In particular, the subject can be undergoing intermittent fasting or a time restricted diet (i.e., the subject only each during a predetermined time for 1 or more days). In a refinement, a subject undergoing or intending to undergo a fast for a predetermined period of time is identified. In a further refinement, the predetermined period of time is from 4 to 24 hours, and in particular, about 18 hours (for example, an 18:6 intermittent fasting).

In a variation, a fasting drink (e.g., a ready-to-drink fasting drink) provides 80 to 200 kcal per 100 grams of the fasting drink; 60 to 150 kcal fat per 100 grams of the fasting drink of which 2 to 30 kcal are from saturated fat. This fasting drink includes per 100 grams of the fasting drink any combination of or all of: 1 to 4 grams protein, 3 to 8 grams carbohydrates, optionally, 1 to 5 grams dietary fiber, 1 to 7 grams total sugar, 1 to 5 grams added sugar, 2 to 7 net carb grams, 8 to 15 grams of fat, 1 to 4 gram of saturate fat, 0.0 to 0.0005 grams of trans fatty acid. In a refinement, this fasting drink includes per 100 grams of the fasting drink any combination of or all of 1 to 3 mcg Vitamin D, 100 to 250 mg calcium, 0.3 to 2 mg iron, 100 to 200 mg potassium, and 80 to 150 mg sodium. In a refinement, this fasting drink includes any combination of or all of macadamia nuts in an amount from about 3 to 10 weight percent; almond meal (e.g., with skins) in an amount from about 3 to 10 weight percent; pecans in an amount from about 3 to 8 weight percent; coconut in an amount from about 1 to 4 weight percent; flaxseed in an amount from about 0.5 to 2 weight percent; coconut oil in an amount from about 0.5 to 2 weight percent; optionally, natural flavor in an amount from about 0.05 to 1 weight percent; optionally, sea salt in an amount from about 0.05 to 0.5 weight percent; coconut palm sugar in an amount from about 3 to 8 weight percent; and optionally, unsweetened almond milk or water or water or another low calories beverage (i.e., less than 20 kilocalorie beverage in an amount from about 60 to 85 weight percent.

The following examples and discussion illustrate the various embodiments of the present invention. Those skilled in the art will recognize many variations that are within the spirit of the present invention and scope of the claims.

1. Meal Replacement Study

In the maintenance of benefits from the Fasting-mimicking Diet, the fasting bar set forth above is used as a fasting-mimicking ‘meal replacement’ bar or a fasting-mimicking’ light meal’ bar that can replace breakfast and/or lunch and/or dinner or a snack. In particular, the fasting bar set forth above can be used for intermittent fasting wherein a subject fasts for 12 to 24 hours but for only intaking the fasting bar for a predetermined number of meals. As set forth above, the fasting bar can include any combination of macadamia nuts; honey; pecans; almonds; almond butter; coconut; inulin; cocoa derivatives; flax seeds; and coconut flour. Characteristically, the fasting bar provides from 100 to 300 kcal of which 40 percent kcal are from fats and 10 to 30 percent kcal are from carbohydrates with less than 10 grams of protein. In a refinement, the predetermined number of meals is 1, 2, or 3 meals.

a. Mechanism of Action:

On a molecular level, fasting is the absence of triggers of the nutrient-sensing pathways present in the cells. Cells take the cues from the presence of nutrients to determine if they should grow or rest/rejuvenate. When the cells detect nutrients in the body, the nutrient-sensing pathways (NSP's) in these cells get activated and led to the downstream effects of cellular growth and replication. When the body is in a fasted state, these NSP's are down-regulated and the cells go into a rejuvenate mode. There are different nutrient sensors in the cells for various nutrients. For example, m-Tor and IGF-1 pathways are activated by the presence of amino acids and proteins. The presence of carbohydrates activates PKA (protein kinase A). Fasting bar contains a specific amount of protein and carbs with unique ingredient mixes when consumed does not trigger the nutrient sensing pathways in the cells. As a result, when the body consumes a Fasting bar, the cells stay in a fasted state. Fasting bar was developed using the same fasting mimicking technology as PROLON®.

b. Study Methods and Results

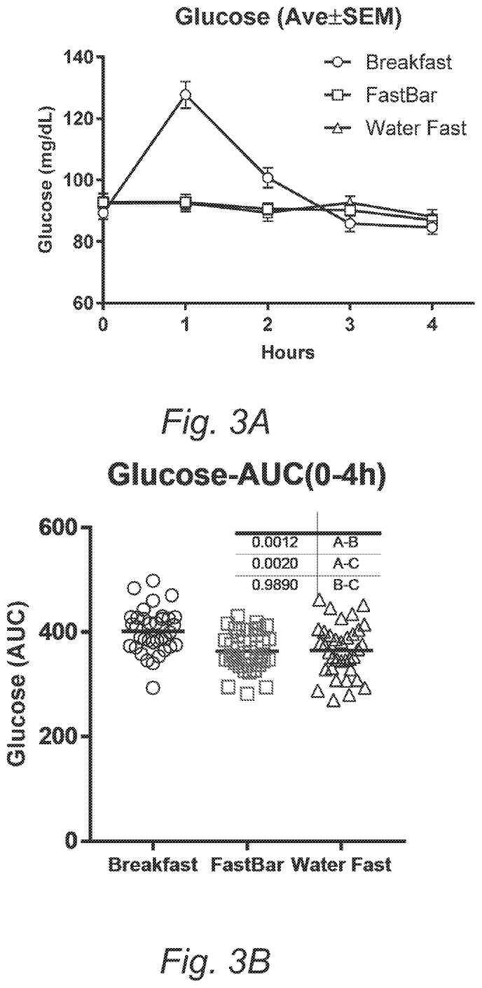

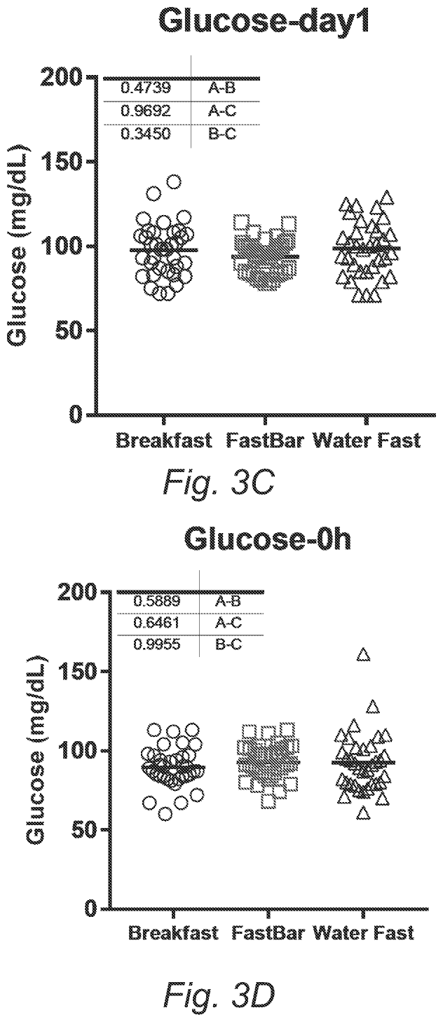

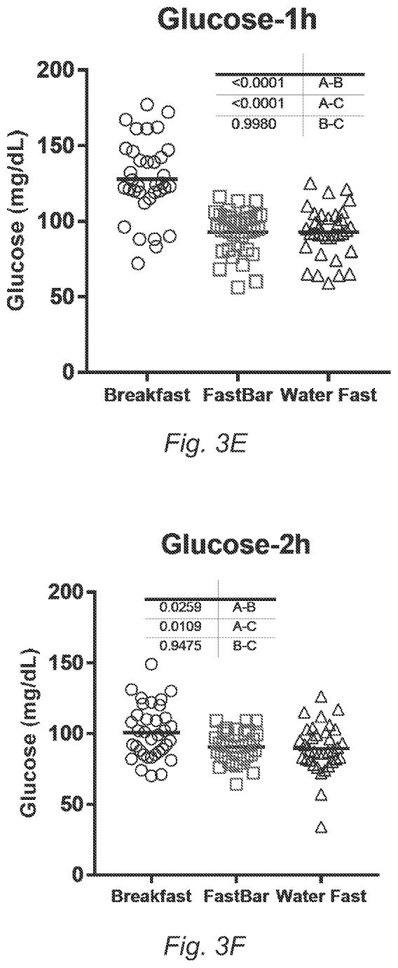

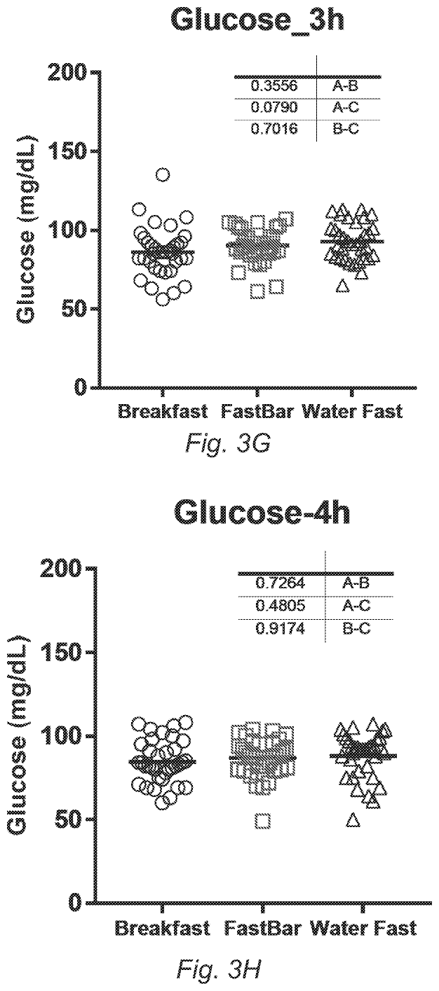

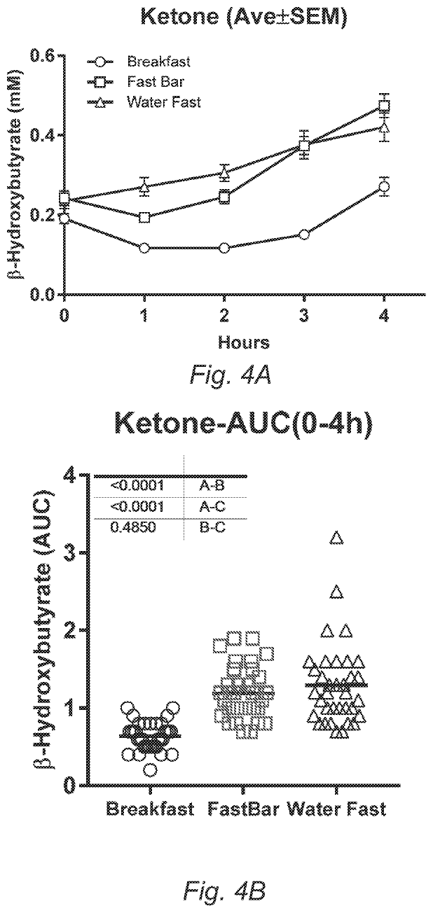

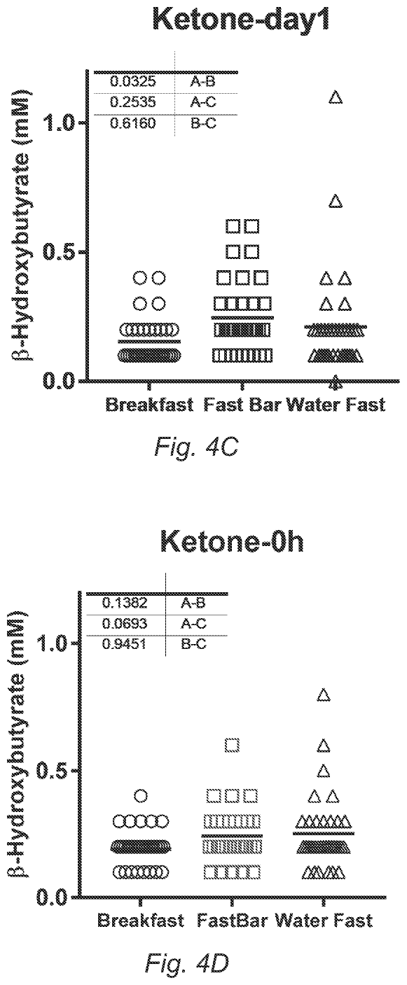

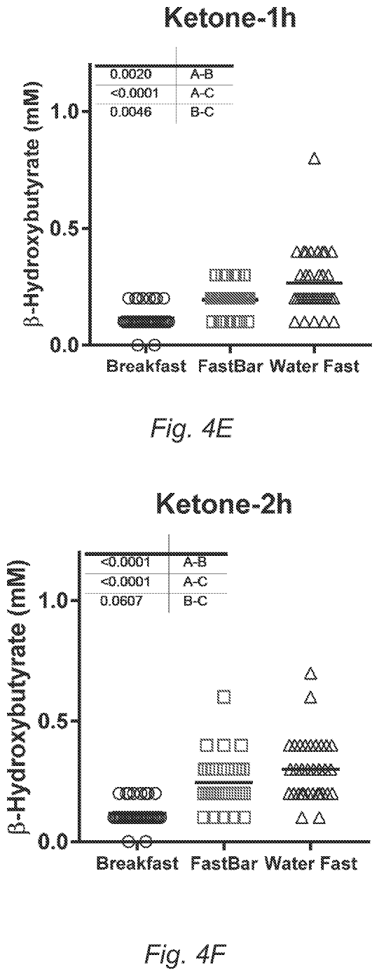

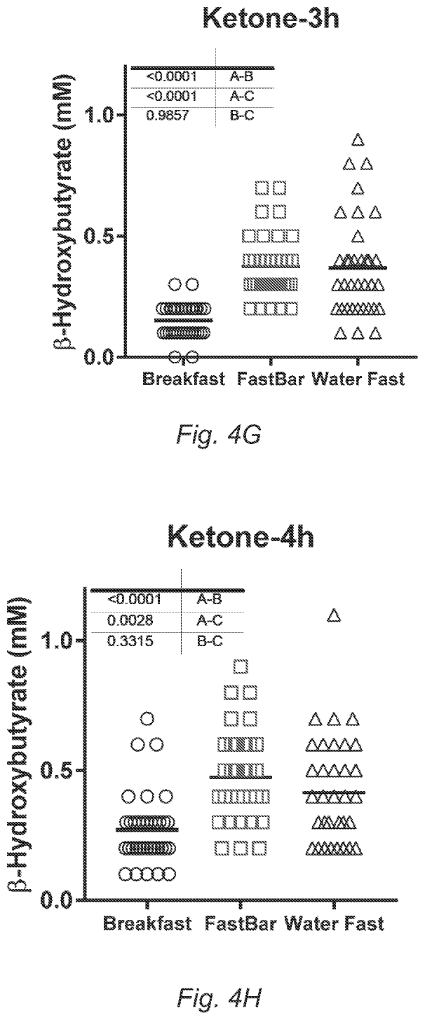

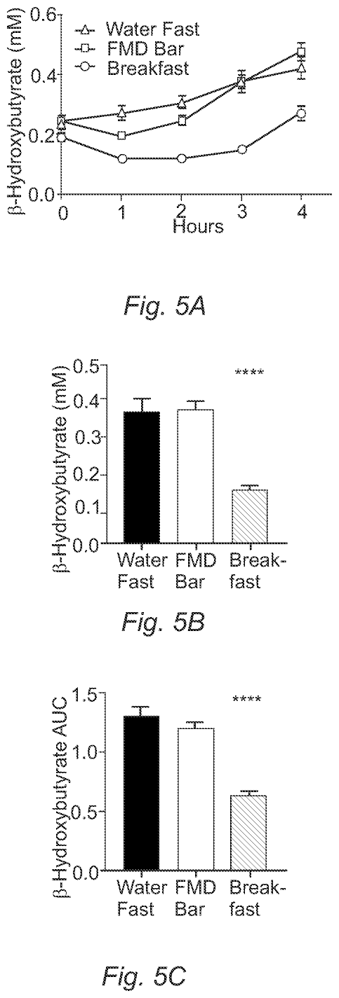

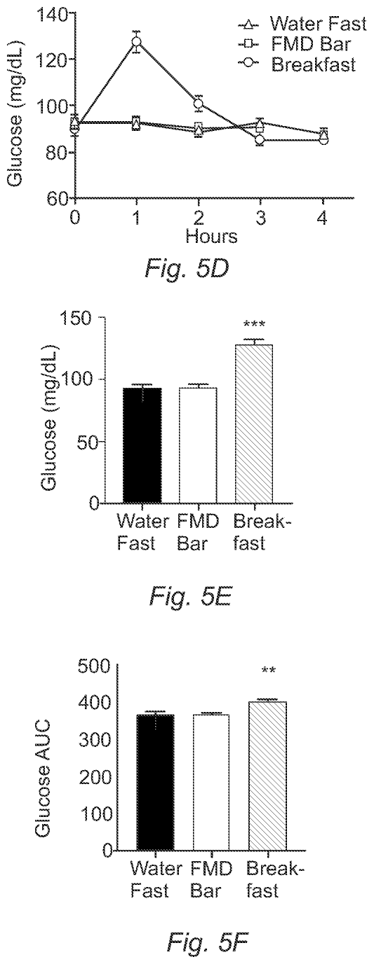

FIGS. 3 and 4 provide the results of a study demonstrating the effectiveness of the fasting bar. The study parameters are as follows: 108 subjects, 15 hours of overnight fast then randomized to 3 groups (Breakfast vs Fasting bar vs Water only). The subjects are tested for glucose and ketone hourly for 4 hours post consumption of the Bar. The primary outcomes are glucose and ketones at 3 hours post bar consumption and 4 hours AUC for glucose and ketone. The results for glucose are summarized by FIGS. 3A and 3B. Significantly, glucose AUC for Fasting bar is significantly lower than the breakfast group (4 hours) (p=0.0012). Surprisingly, there is no difference between the glucose AUC for water-only vs Fasting bar over 4 hours (p=0.9890). It is also observed that there is no difference in glucose level at the 3^{rd} hour between any groups. Glucose levels track similarly between the Fasting bar group and the water-only group

FIGS. 4A and 4B summarize the results for ketones. The ketone AUC for the Fasting bar group is significantly higher than the breakfast group (4 hours) (p=<0.0001). There is no significant difference in ketone AUC between the Fasting bar group and the water-only group (p=0.4850). The ketone level for the Fasting bar group is significantly higher than the breakfast group at 3 hours (p<0.0001). The ketone level for the Fasting bar group is not different than the water-only group at 3 hours (p=0.9857).

2. Fasting Bar Study 1

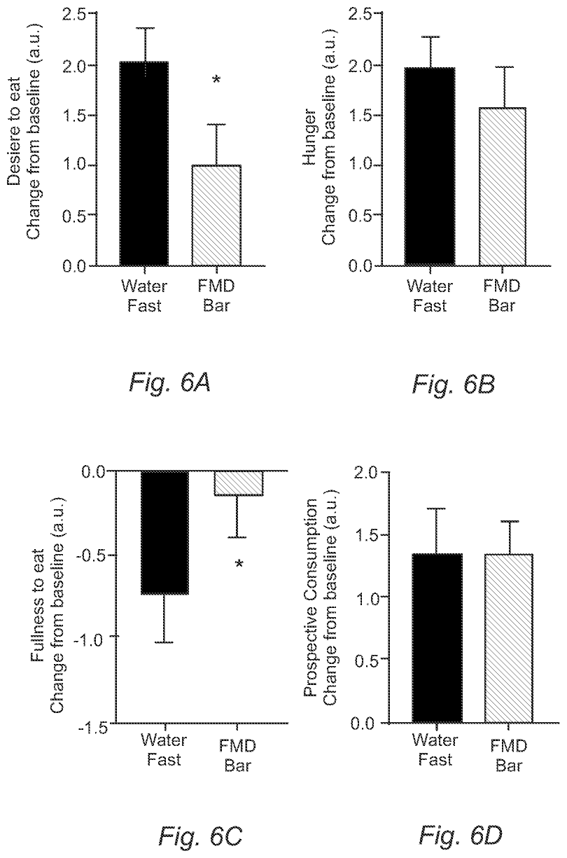

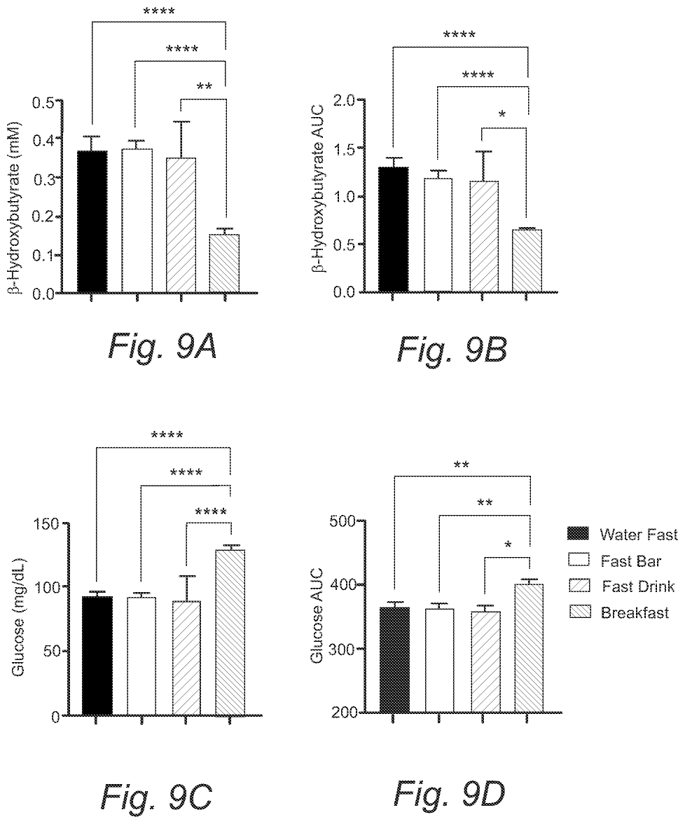

Referring to FIGS. 9A-9F, after 15 hours of fasting overnight, fasting-mimicking diet bar (also termed FMD Bar™ or Fasting Bar™) consumption led to similar levels of 3-h postprandial blood ketone and ketone AUC₀₋₄ as those of water-only fast. The Fasting Bar™ despite containing nutrients, did not elicit a 1-h postprandial glucose elevation in contrast to the breakfast. Human studies demonstrated that manipulation of energy intake and macronutrient composition can extend physiological ketogenesis similar to water fast while providing some energy and nutrients to increase the sense of fullness and satiety. FIG. 6 plots changes in subjective measures at 3 h post Fasting Bar™ consumption. FIG. 6A addresses the inquiry “How strong is your desire to eat?”; FIG. 6B addresses the inquiry “How hungry do you feel?”; FIG. 6C addresses the inquiry “How full do you feel?”; FIG. 6D addresses the inquiry How much food do you think you could eat?” FIGS. 6A, 6B, and 6C indicate that the fasting bar resulted in a positive perception compared to the water fast.

3. Fasting Bar Study 2

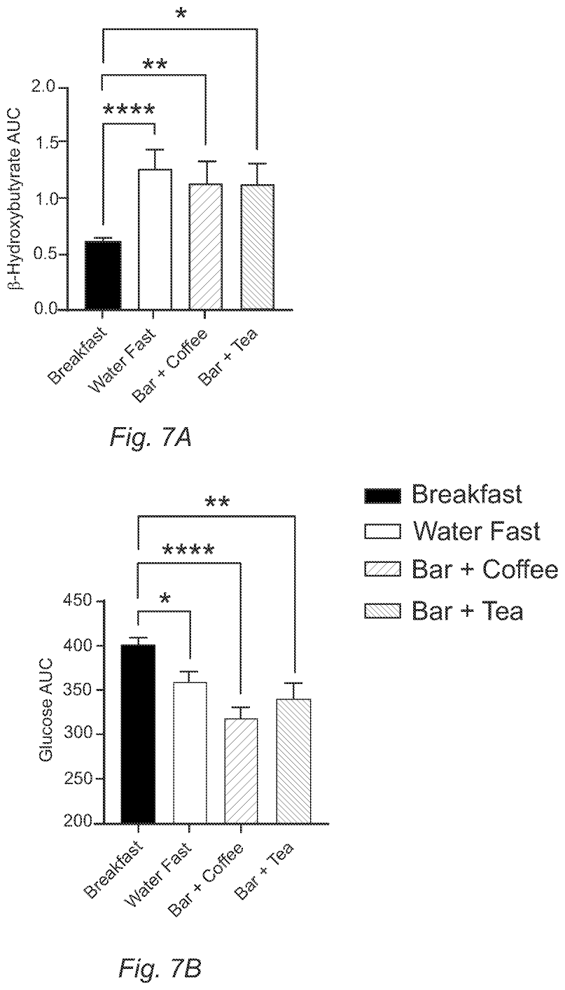

Referring to FIGS. 7A-7B, consumption of Fasting Bar™ with or without coffee/tea after a 15-hour overnight fast led to similar physiological changes in terms of ketogenesis and glucose levels compared to that of water fast. Surprisingly, the consumption of coffee or tea did not impact the fasting state.

4. Fasting Bar 2 Study 3

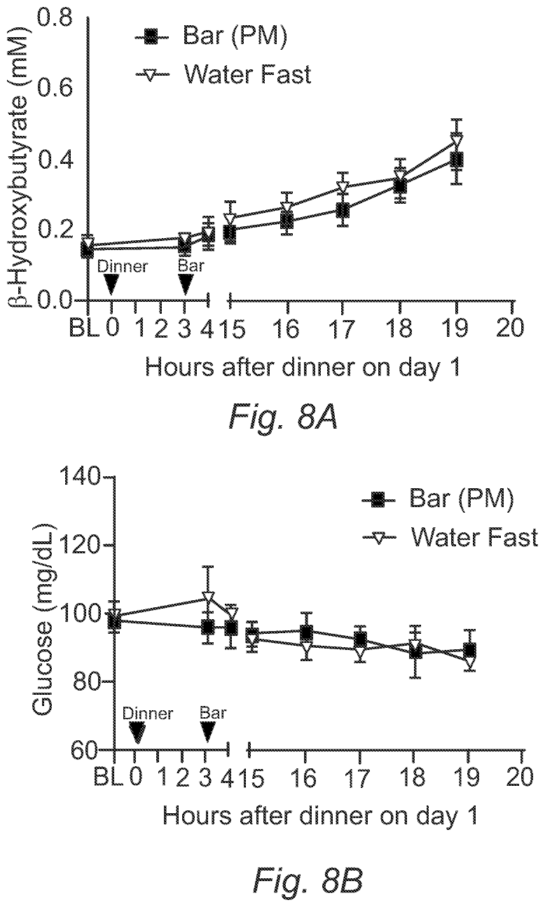

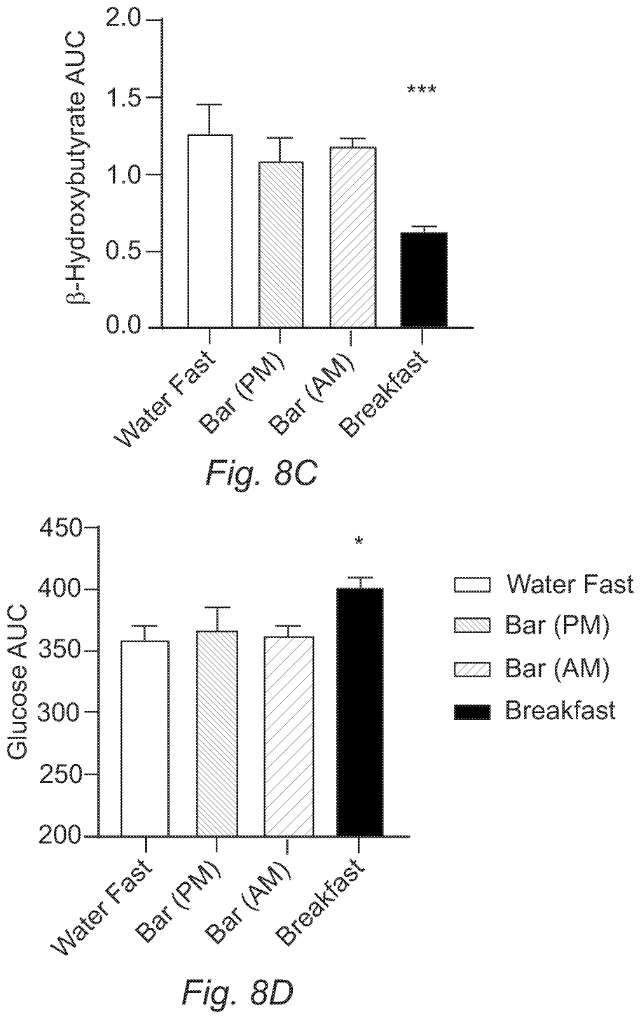

Referring to FIGS. 8A-8D, consumption of Fasting Bar™ in the night or in the morning does not interfere a 15-hour overnight fast in terms of ketogenesis and glucose levels compared to that of water fast.

5. Fasting Drink Study Summary

Referring to FIGS. 9A-9D, after 15 hours of fasting overnight, Fasting Bar™ and Fast Drink™ consumption led to similar levels of 3-h postprandial blood ketone and ketone area under the curve (AUC0-4) as those of water-only fast. Breakfast consumption led to a blood glucose increase 1 hour after food consumption. However, post-prandial elevation of glucose level was absent in subjects consuming either the Fasting Bar™ or the Fast Drink™. In fact, post-prandial glucose AUC0-4 of Fasting Bar™ and Fast Drink™ groups were similar to that of Water Fast group.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fasting bar for intermittent fasting or for a fasting-mimicking diet, the fasting bar comprising:
total fat in an amount that provides from about 350 to about 700 kcal per 100 grams of fasting bar;
carbohydrates in an amount that provides from about 75 to 135 kcal per 100 grams of fasting bar; and
proteins in an amount that provides from about 30 to about 60 kcal per 100 grams of fasting bar.

2. The fasting bar of claim 1 further comprising saturated fats in an amount that provides from about 80 to 130 kcal of saturated fat per 100 grams of fasting bar;

3. The fasting bar of claim 1 further comprising about 2 to 10 grams of fiber per 100 grams of fasting bar.

4. The fasting bar of claim 1 including:
about 40 to 60 grams total fat;
optionally about 8 to 15 grams are saturated fat per 100 grams of fasting bar;
about 20 to 40 grams carbohydrates per 100 grams of fasting bar; and
about 5 to 15 grams proteins per 100 grams of fasting bar.

5. The fasting bar of claim 1, wherein:
fat is present in an amount from 40 to 60 weight percent;
carbohydrates are present in an amount from about 20 to 40 weight percent;
proteins are present in an amount from about 5 to 20 weight percent.

6. The fasting bar of claim 1 comprising a combination of at least 3 components selected from the group consisting of macadamia nuts; pecans; almonds; almond meal; almond butter; coconut; inulin; flax seeds; cocoa derivatives; and coconut flour.

7. The fasting bar of claim 1 wherein the fasting bar keeps a subject in a fasted state, extends a fast, does not break the fast in between meals and allows the subject to fast with food or fast for longer or curb hunger while they fast and wherein the fasting bar does not break the fast over night when consumed in the evening.

8. The fasting bar of claim 1 wherein consumption of the fasting bar with coffee and tea does not break a fasting state.

9. A fasting bar for intermittent fasting or for a fasting-mimicking diet, the fasting bar comprising:
total fat in an amount that provides from about 250 to about 500 kcal per 100 grams of fasting bar;
optionally saturated fats in an amount that provides from about 25 to 70 kcal of saturated fat per 100 grams of fasting bar;
carbohydrates in an amount that provides from about 100 to 160 kcal per 100 grams of fasting bar; and
proteins in an amount that provides from about 30 to about 60 kcal per 100 grams of fasting bar.

10. The fasting bar of claim 9 further comprising about 2 to 10 grams of fiber per 100 grams of fasting bar.

11. The fasting bar of claim 10 including:
about 25 to 55 grams total fat;
about 2 to 8 grams are saturated fat per 100 grams of fasting bar;
about 25 to 50 grams carbohydrates per 100 grams of fasting bar; and
about 5 to 15 grams proteins per 100 grams of fasting bar.

12. The fasting bar of claim 10, wherein:
fat is present in an amount from 30 to 60 weight percent;
carbohydrates are present in an amount from about 20 to 50 weight percent;
proteins are present in an amount from about 5 to 20 weight percent.

13. The fasting bar of claim 10 comprising a combination of at least 3 components selected from the group consisting of macadamia nuts; pecans; almonds; almond meal; almond butter; coconut; inulin; flax seeds; cocoa derivatives; and coconut flour.

14. The fasting bar of claim 1 wherein the fasting bar keeps a subject in a fasted state, extends a fast, does not break the fast in between meals and allows the subject to fast with food or fast for longer or curb hunger while they fast and wherein the fasting bar does not break the fast over night when consumed in the evening.

15. A fasting bar for intermittent fasting or for a fasting-mimicking diet, the fasting bar comprising:
total fat in an amount that provides from about 130 to about 300 kcal per 100 grams of fasting bar;
carbohydrates in an amount that provides from about 130 to 300 kcal per 100 grams of fasting bar; and
proteins in an amount that provides from about 30 to about 55 kcal per 100 grams of fasting bar.

16. The fasting bar of claim 15 further comprising saturated fats in an amount that provides from about 20 to 60 kcal of saturated fat per 100 grams of fasting bar;

17. The fasting bar of claim 15 further comprising about 2 to 10 grams of fiber per 100 grams of fasting bar.

18. The fasting bar of claim 15 including:
about 15 to 35 grams total fat;
about 1 to 5 grams are saturated fat per 100 grams of fasting bar;
about 40 to 70 grams carbohydrates per 100 grams of fasting bar; and
about 5 to 15 grams proteins per 100 grams of fasting bar.

19. The fasting bar of claim 15, wherein:
fat is present in an amount from 10 to 25 weight percent;
carbohydrates are present in an amount from about 40 to 70 weight percent;
proteins are present in an amount from about 5 to 20 weight percent.

20. The fasting bar of claim 15 comprising a combination of at least 3 components selected from the group consisting of macadamia nuts; pecans; almonds; almond meal; almond butter; coconut; inulin; flax seeds; cocoa derivatives; and coconut flour.

21. The fasting bar of claim 15 wherein the fasting bar keeps a subject in a fasted state, extends a fast, does not break the fast in between meals and allows the subject to fast with food or fast for longer or curb hunger while they fast and wherein the fasting bar does not break the fast over night when consumed in the evening.

22. A fasting-mimicking diet package including the fasting bar of claim 1.

23. The fasting bar of claim 1 wherein the fasting bar is a fasting-mimicking meal replacement bar or a fasting-mimicking light meal bar that can replace breakfast, lunch or dinner.

24. A method of intermittent fasting or time restricted eating or time restricted feeding comprising:
fasting by a subject for 12 up to 24 hours only intaking the fasting bar of claim 1 for a predetermined number of meals.

25. The method of claim 24 wherein the predetermined number of meals is 1, 2, or 3 meals.

26. A method comprising:
identifying a subject in need of a fasting-mimicking diet; and
providing the subject with the fasting-mimicking diet having less than about 10 percent calories from protein sources, the fasting-mimicking diet providing at most 50% of the normal caloric intake of the subject with at least 50% of kilocalories provided being derived from fat, wherein the fasting-mimicking diet includes the fasting bar of claim 1.

27. The method of claim 26 wherein the fasting-mimicking diet provides the subject with from about 300 to 1200 kcal per day.

28. The method of claim 26 further comprising monitoring glucose and/or IGF-1 levels of the subject.

29. The method of claim 26 wherein the fasting-mimicking diet is administered to the subject for a first time period from 1 day to 14 days.

30. The method of claim 29 wherein the fasting-mimicking diet provides from 3 to 7 kilocalories per pound of the subject.

31. The method of claim 29 further comprising administering a second diet to the subject for a second time period following the fasting-mimicking diet wherein the second diet provides an overall calorie consumption that is within 20 percent of a subject's normal calorie consumption for 25 to 26 days.

32. The method of claim 29 wherein the fasting-mimicking diet includes an amino acid specific supplement.

33. The method of claim 26 wherein the fasting-mimicking diet allows the subject to fast with food and receive many benefits of a prolonged fast including metabolic health, cellular autophagy, weight loss of visceral fat, an improved relationship with food or reduced food cravings, increased energy and mental clarity.

34. A method for extending a fast, the method comprising:
providing a fasting bar to a subject for extending a fasting state, the fasting bar comprising:
total fat in an amount that provides from about 350 to about 700 kcal per 100 grams of the fasting bar;
carbohydrates in an amount that provides from about 75 to 135 kcal per 100 grams of the fasting bar; and
proteins in an amount that provides from about 30 to about 60 kcal per 100 grams of the fasting bar.

35. The method of claim 34 wherein the fasting bar further comprises saturated fats in an amount that provides from about 80 to 130 kcal of saturated fat per 100 grams of fasting bar;

36. The method of claim 34 wherein the fasting bar further comprises about 2 to 10 grams of fiber per 100 grams of fasting bar.

37. The method of claim 34 wherein the fasting bar includes:
about 40 to 60 grams total fat;
optionally about 8 to 15 grams are saturated fat per 100 grams of fasting bar;
about 20 to 40 grams carbohydrates per 100 grams of fasting bar; and
about 5 to 15 grams proteins per 100 grams of fasting bar.

38. The method of claim 34 wherein the fasting bar includes:
fat in an amount from 40 to 60 weight percent;
carbohydrates in an amount from about 20 to 40 weight percent;
proteins in an amount from about 5 to 20 weight percent.

39. The method of claim 34 wherein the fasting bar includes a combination of at least 3 components selected from the group consisting of macadamia nuts; pecans; almonds; almond meal; almond butter; coconut; inulin; flax seeds; cocoa derivatives; and coconut flour.

40. The method of claim 34 wherein the fasting bar keeps a subject in a fasted state, extends a fast, does not break the fast in between meals and allows the subject to fast with food or fast for longer or curb hunger while they fast.

41. A drink powder composition for making a fasting drink, the drink powder composition comprising:
total fat in an amount that provides from about 300 to about 700 kcal per 100 grams of the drink powder composition;
carbohydrates in an amount that provides from about 50 to 150 kcal per 100 grams of the drink powder composition; and
proteins in an amount that provides from about 30 to about 60 kcal per 100 grams of the drink powder composition.

42. The drink powder composition of claim 41 formed from ingredients selected from the group consisting of extra virgin olive oil, soluble tapioca fiber, chickpea protein concentrate, cane sugar, vanilla, gum blend (guar gum, gum acacia, xanthan gum), tricalcium phosphate, vegetable blend (broccoli, spinach, kale, pumpkin, sweet potato, sunflower seed, cranberry, chlorella, maitake mushroom and shitake mushroom), medium chain triglycerides, acacia gum, tocopherols, and combination thereof.

43. The drink powder composition of claim 41 formed from ingredients selected from the group consisting of extra virgin olive oil, soluble tapioca fiber, chickpea protein concentrate, coconut palm sugar, vanilla, gum blend (guar gum, gum acacia, xanthan gum), tricalcium phosphate, vegetable blend (broccoli, spinach, kale, pumpkin, sweet potato, sunflower seed, cranberry, chlorella, maitake mushroom and shitake mushroom), medium chain triglycerides, acacia gum, tocopherols, and combinations thereof.

44. The drink powder composition of claim 41 wherein the fasting drink keeps a subject in a fasted state, extends a fast, does not break the fast in between meals and allows the subject to fast with food or fast for longer or curb hunger while they fast and wherein the fasting drink does not break the fast over night when consumed in the evening.

45. The drink powder composition of claim 41 wherein consumption of the fasting drink with coffee and tea does not break a fasting state.

46. The drink powder composition of claim 41 wherein the drink powder composition is formed from its ingredients by grinding and/or freeze drying.

47. A ready to drink fasting drink composition comprising:
total fat in an amount that provides from about 300 to about 700 kcal per 100 grams of the drink powder composition;
carbohydrates in an amount that provides from about 50 to 150 kcal per 100 grams of the drink powder composition; and
proteins in an amount that provides from about 30 to about 60 kcal per 100 grams of the drink powder composition.
